(19) United States
(12) Patent Application Publication
(10) Pub. No.: US 2014/0058866 A1
(43) Pub. Date: Feb. 27, 2014

(54) PAYMENT SYSTEM, SERVER, INFORMATION PROCESSING APPARATUS, AND COMPUTER PROGRAM PRODUCT

(71) Applicant: GLOBAL RIGHT, INC., Tokyo (JP)

(72) Inventor: Yoshinobu OKADOME, Tokyo (JP)

(73) Assignee: GLOBAL RIGHT, INC., Tokyo (JP)

(21) Appl. No.: 13/971,045

(22) Filed: Aug. 20, 2013

(30) Foreign Application Priority Data
Aug. 22, 2012 (JP) 2012-183353

(51) Int. Cl. G06Q 20/20

(52) U.S. Cl. CPC G06Q 20/202
USPC 705/21

(57) ABSTRACT

A payment system includes an information processing apparatus, a sales terminal, and a server that are configured to establish communication with each other. The server includes a member information database that has ID information stored in association with a member ID of a member of the payment system; a member ID receiving unit that receives the member ID from the information processing apparatus; a member identifying unit that refers to the member information database and identifies the member ID associated with the ID information; a sales information transmitting unit that transmits the sales information that has been transmitted from the sales terminal along with the ID information; and a payment processing request unit that receives from the information processing apparatus card information to be used to pay the payment amount indicated in the sales information and transmits a payment processing request including the card information to a financial institution.

### BACKGROUND OF THE INVENTION

1. Field of the Invention

The present invention relates to a payment system that enables communication between an information processing apparatus, a sales terminal, and a server via a network.

2. Description of the Related Art

Payment methods that do not involve the direct payment of cash are known. For example, in the case of using a credit card, a transaction may be completed by a customer handing his/her credit card to a store clerk and a terminal device at the store reading credit card information of the credit card.

FIG. 18 schematically illustrates exemplary procedures of such a payment system.

(1) A customer selects a desired product or service at a store (e.g., shoes in the illustrated example) and hands his/her credit card to a store clerk to pay for the selected item. The store clerk uses a terminal device such as a Credit Authorization Terminal (CAT) to read card information of the credit card.

(2) At the store, the store clerk operates a Point of Sale (POS) register, for example, to read barcode information of the selected item, and sends the barcode information, the total amount of payment, the card information, and a member store code to a bank or a credit card company using a system such as Credit and Finance Information Switching (CAFIS) system.

(3) The bank or the credit card company conducts authorization based on the card information and the total amount, checks whether any restrictions such as the transaction limit, delay in payment, or suspension apply, and sends a payment complete notification to the CAFIS terminal if no restrictions apply.

After confirming the receipt of the payment complete notification, the store clerk returns the credit card to the customer, and may hand the purchased item to the customer along with a printed receipt, for example. The transaction procedures in a case where a debit card is used may be similar to the above-described procedures but may include an additional step of having the customer input a PIN (personal identification number) or some other type of pass code. The amount paid is withdrawn from a bank account of the customer on the day of the transaction in the case where a debit card is used and on a later date in the case where a credit card is used, and in this way the payment is completed.

In addition to using a credit card or a debit card, a customer may use electronic money to make a payment. In the case of using electronic money, the customer may hold a dedicated card or terminal over a reader at a store to make a payment. An amount charged (added) to the dedicated card or terminal may be withdrawn from the bank account of the customer on a later date, for example.

In the case of making a payment using electronic money, the customer hold on to his/her card or terminal at all times. However, in the case of making a payment with electronic money, the amount of payment cannot exceed the current balance of the electronic money. Thus, the customer has to keep track of the balance and charge his/her card or terminal as is necessary. This may be an inconvenience for the customer.

Although a credit card does not have such drawbacks, the customer that wishes to make a payment with a credit card has to hand his/her credit card to a store clerk. Although there are stores that allow the customer to load his/her credit card into a DOS register, the customer has to at least carry his/her credit card. In this respect, for example, Japanese Laid-Open Patent Publication No. 2002-92497 (referred to as “Patent Document 1” hereinafter) discloses a system enabling a customer to make a payment without carrying his/her credit card.

Patent Document 1 discloses a settlement system for a store in which a cell phone carried by a customer establishes communication with a DOS system of a store through short-range wireless communication to transmit credit card information to the POS system. Based on such a system, the customer does not need to carry cash nor a credit card but only his/her cell phone to make a payment.

However, the payment method disclosed in Patent Document 1 may have security issues because any given cell phone that responds to a short-range wireless communication may transmit credit card information to the POS system. That is, any cell phone within the communication range of the POS system may be prompted to send credit card information to the POS system.

Also, the payment method disclosed in Patent Document 1 has security issues in that it involves a cell phone sending credit card information to a POS system. That is, because credit card information is sensitive information that may potentially be abused by a third party that gains unauthorized access to the information, it is not prudent to send such information to the POS system or allow the POS system to store such information.

In consideration of the above, simply replacing a credit card with a cell phone to allow a user to make a payment without his/her credit card may not be adequate.

The same applies to online or distance shopping. In online or distance shopping, the customer does not have to bring his/her credit card to a store. However, upon making a payment online via a website, for example, the customer must input his/her credit card information and send the credit card information to the website. Thus, the website may retain the credit card information transmitted from the customer. Although the online store may be operating the website in good faith, there is still a risk of leakage of the credit card information, and the customer may not feel comfortable about the website holding onto the customer's credit card information.

### SUMMARY OF THE INVENTION

It is a general object of at least one embodiment of the present invention to provide a payment system that substantially obviates one or more problems caused by the limitations and disadvantages of the related art. It is one specific object of at least one embodiment of the present invention to provide a payment system for enabling payment without the use of cash that does not require the storage or retention of card information of a card to be used by a customer at a location beyond the control of the customer.

According to one embodiment of the present invention, a payment system includes an information processing apparatus, a sales terminal, and a server that are configured to establish communication with each other. The sales terminal includes an ID information obtaining unit (e.g., ID information obtaining unit 131) that obtains ID information of an IC chip, which is installed in or attached to the information processing apparatus; a sales information generating unit (e.g., sales information generating unit 133) that generates sales information including a payment amount, which is obtained based on product information of a product to be sold; and an ID/sales information transmitting unit (e.g., sales information transmitting unit 132) that transmits the ID information and the sales information to the server. The server includes a member information database (e.g., member DE 126) that has the ID information stored in association with a member ID of a member of the payment system; a member ID receiving unit (e.g., member ID receiving unit 122) that receives the member ID from the information processing apparatus; a member identifying unit (e.g., member identifying unit 123) that refers to the member information database and identifies the member ID associated with the ID information transmitted from the sales terminal; a sales information transmitting unit (e.g., payment information transmitting unit 122) that transmits the sales information, which has been transmitted from the sales terminal along with the ID information, to the information processing apparatus that has transmitted the member ID identified by the member identifying unit; and a payment processing request unit (payment processing unit 125) that receives from the information processing apparatus card information of a card to be used to pay the payment amount indicated in the sales information and transmits a payment processing request including the card information to a financial institution that has issued the card. The information processing apparatus includes a member ID transmitting unit (e.g., member ID transmitting unit 115) that transmits the member ID to the server; a payment approval accepting unit (e.g., display unit 111 and operation accepting unit 112) that displays the sales information received from the server and accepts a payment approval; a card information transmitting unit (e.g., card information transmitting unit 114) that transmits the card information that is stored beforehand to the server when the payment accepting unit accepts the payment approval.

According to one aspect of the present invention, a payment system for enabling payment without the use of cash may be provided that does not require the storage or retention of card information of a card to be used by a customer at a location beyond the control of the customer.

### BRIEF DESCRIPTION OF THE DRAWINGS

FIG. 1 schematically illustrates an exemplary configuration of a payment system according to a first embodiment of the present invention;

FIG. 2 is a block diagram illustrating an exemplary hardware configuration of a mobile terminal;

FIG. 3 is a block diagram illustrating an exemplary hardware configuration of a server;

FIGS. 4A and 4B illustrate exemplary ways of attaching an IC chip to the mobile terminal;

FIGS. 5A and 5B illustrate exemplary procedures for registering member data;

FIG. 6 illustrates exemplary process steps of a first stage of a member registration process;

FIG. 7 illustrates exemplary process steps of a second stage of the member registration process;

FIG. 8 is a block diagram illustrating functional features of the payment system;

FIGS. 9A-9D are tables illustrating exemplary data structures of data stored in association with a member ID;

FIG. 10 is a table illustrating an exemplary data structure of product information stored in a product database;

FIG. 11 is a flowchart illustrating exemplary operation process steps of the payment system that are executed upon purchasing an item;

FIG. 12 illustrates exemplary screen transitions of the mobile terminal;

FIG. 13 illustrates exemplary screen transitions of the mobile terminal;

FIGS. 14A-14D illustrate exemplary screens of a POS register;

FIGS. 15A and 155 illustrate exemplary screens of the POS register;

FIG. 16 schematically illustrates an exemplary configuration of a payment system according to a second embodiment of the present invention;

FIG. 17 is a flowchart illustrating exemplary operation process steps of the payment system of the second embodiment that are executed upon purchasing an item;

FIG. 18 schematically illustrates exemplary payment procedures implemented in a conventional payment system.

### DESCRIPTION OF THE PREFERRED EMBODIMENT

In the following, embodiments of the present invention will be described with reference to the accompanying drawings.

### First Embodiment

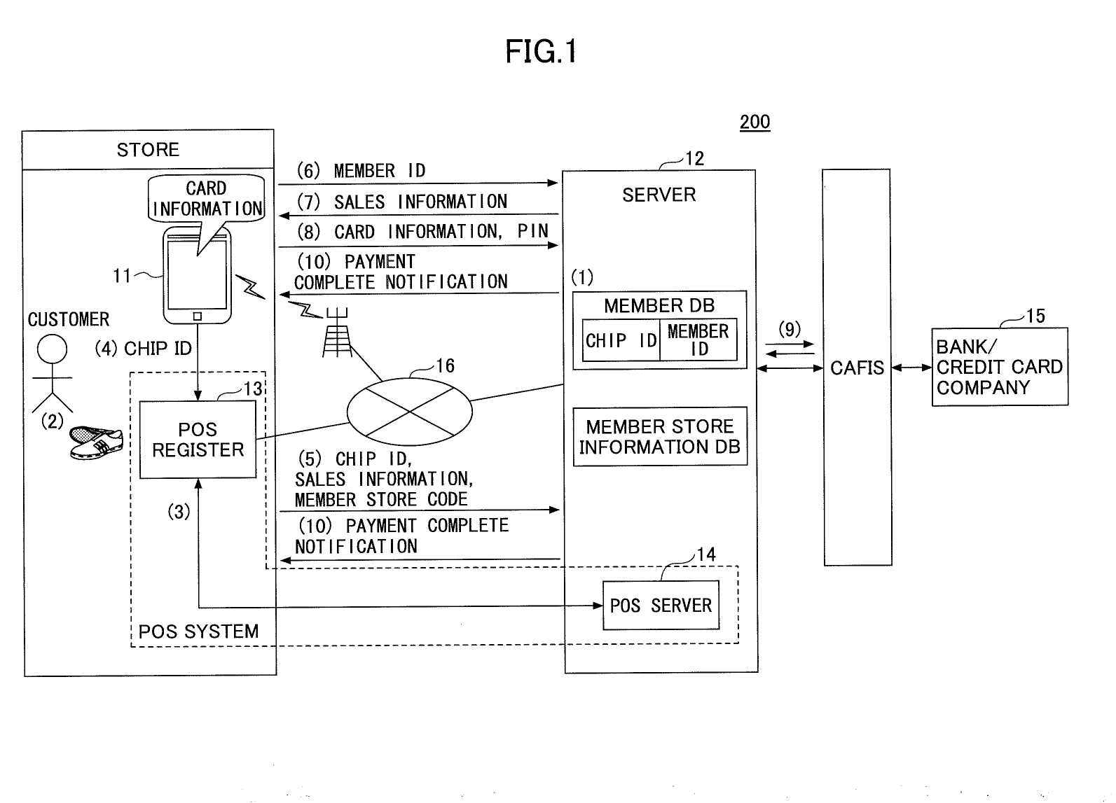

FIG. 1 is a block diagram illustrating a schematic configuration of a payment system according to a first embodiment of the present invention. The present embodiment relates to an application-type payment system. The application-type payment system is a system in which a dedicated application that is downloaded to an information processing apparatus such as a mobile terminal is configured to make a payment via a server.

(1) A customer is registered as a member in a payment system 200 of the present embodiment. The customer is assigned a member ID for identifying the customer as a member of the payment system 200.

Also, a chip ID of an IC chip that is substantially integrated with a mobile terminal 11 of the customer is registered in association with the member ID in a server 12 according to an in-store member registration method, which is described below. The customer carries the mobile terminal 11 with the integrated IC chip. The server 12 includes a member store information DB that stores information on member stores that are registered with the payment system 200 of the present embodiment.

(2) The customer selects a desired product or service at a store (e.g., shoes in the illustrated example).

(3) At the store side, for example, a store clerk (cashier) may operate a POS register 13 to read a barcode of the selected product and obtain product information from a product database of a POS server 14. The product information includes information items such as the product code identifying the product and the price of the product, for example. The total amount of payment is calculated based on the price included in the product information. Then, sales information including the total amount and the product information is generated.

(4) The customer inputs the chip ID to the POS register 13 using radio frequency identification (RFID), for example.

(5) The POS register 13 transmits the chip ID and the sales information together with a member store code of the store to the server 12.

(6) The mobile terminal 11 inputs the member ID and transmits the member ID to the server 12 via a public line.

(7) The server 12 searches a member DE to identify the member ID stored in association with the chip ID transmitted from the POS register 13, and in the case where the identified member ID matches the member ID transmitted from the mobile terminal 11, the server 12 transmits the sales information transmitted from the POS register 13 to the mobile terminal 11.

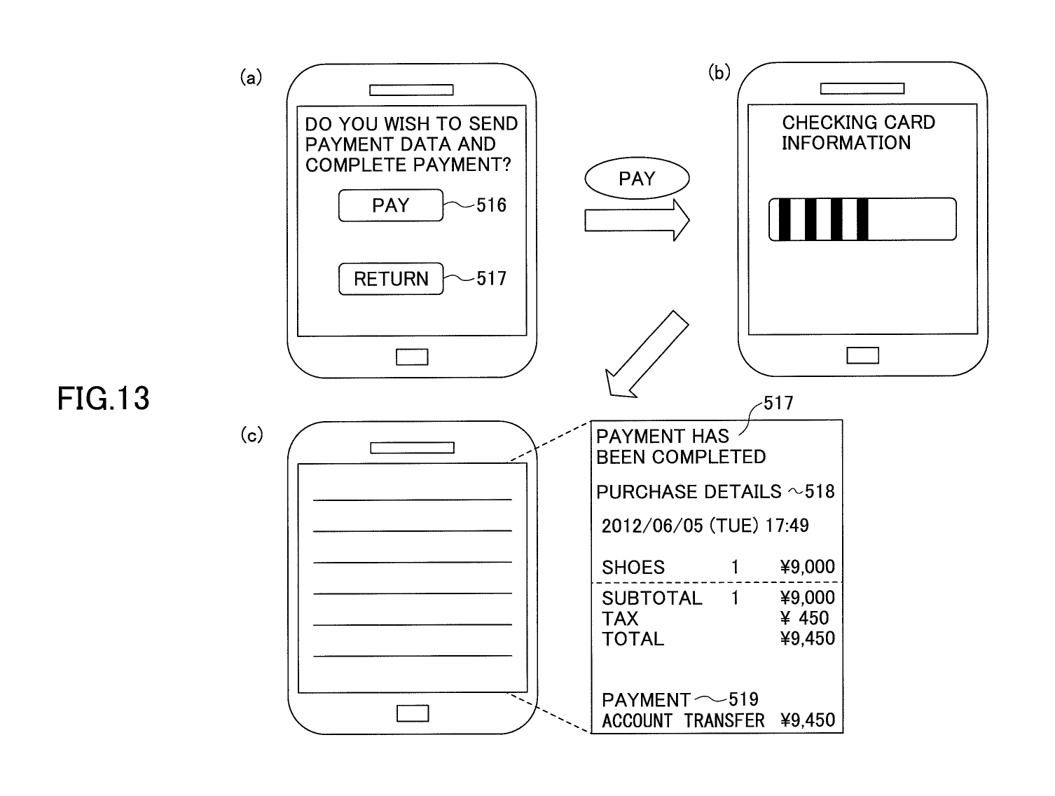

(8) The customer checks the content of the sales information such as the total amount and the product name. After confirming the accuracy of the information, the customer inputs his/her PIN and presses a “PAY” button (e.g., “PAY” button 516 of FIG. 13), which is described below. In this way, the card information and PIN are transmitted to the server 12.

(9) The server 12 transmits the card information of the credit card or cash card to used together with member store information, which may be obtained from the member store information DB based on the member store code transmitted from the POS register 13, to the bank/credit card company that has issued the card. In this way, a payment processing request may be made.

(10) The server 12 then transmits a payment complete notification to the POS register 13 and the mobile terminal 11 of the customer.

As can be appreciated, in the payment system 200 of the present embodiment, because the server 12 has a chip ID registered in association with a corresponding member ID, the chip ID and the member ID may be transmitted separately. Thus, the mobile terminal 11 may make a cashless payment at a store without having to transmit card information to the POS register 13 or some other sales terminal at the store.

Note that although an exemplary case of making a payment using a credit card is described below, similar procedures may be implemented in a case where a debit card is used.

[Configuration]

In the following, an exemplary configuration of the payment system 200 illustrated in FIG. 1 is described. The store has a POS system including the POS register 13 and the POS server 14. The POS register 13 includes a RFID reader. The POS register 13 and the POS server 14 are connected to via a network such as a dedicated line, a LAN (local area network), or a VPN (virtual private network).

The POS register 13 and the server 12 are connected via a network 16 so that they may establish communication with each other. The network 16 may be a LAN, a WAN (wide area network) that interconnects a plurality of LANs, or the Internet, for example. In one preferred embodiment, a part of the network 16 may comprise a wireless communication network such as a wireless LAN network, and such a wireless communication network may be set up using a mobile telephone network or WiMAX (Worldwide interoperability for Microwave Access) network, for example.

The customer possesses the mobile terminal 11. The mobile terminal 11 may be a smartphone, a tablet PC, a slate PC, a cell phone, a PDA (personal digital assistant), or a notebook PC, for example. The mobile terminal 11 may be any other type of information processing apparatus that is capable establishing communication (preferably wireless communication) with the server 12. Also, the mobile terminal 11 does not necessarily have to be carried at all times.

The mobile terminal 11 and the server 12 are connected to each other via the network so that they may establish communication with each other. The network 16 may be connected to a base station of a mobile telephone network or WiMAX network, or an access point of a wireless LAN, for example. The mobile terminal 11 establishes connection with the base station or the access point through wireless communication and then establishes communication with the server 12 via an IP network (network using the Internet protocol).

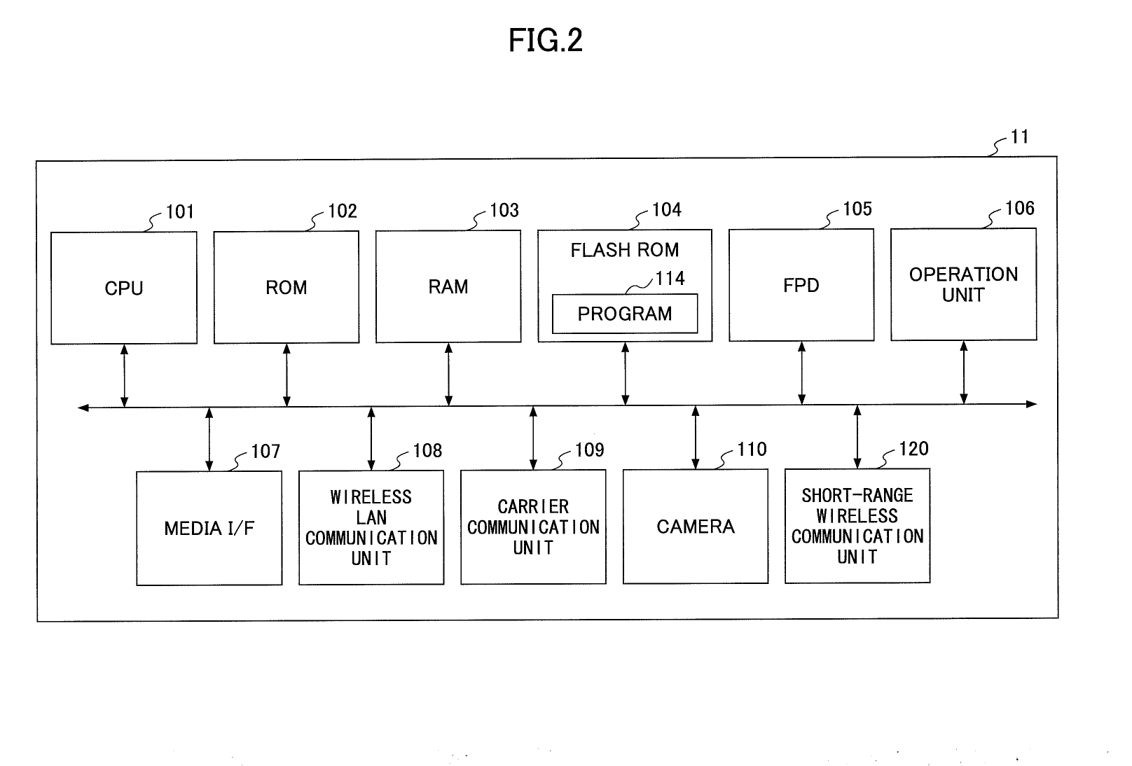

FIG. 2 is a block diagram illustrating an exemplary hardware configuration of the mobile terminal 11. The mobile terminal 11 includes a CPU 101, a ROM 102, a RAM 103, a flash ROM 104, a FED (full page display) 105, an operation unit 106, a media I/F (interface) 107, a wireless communication unit 108, a carrier communication unit 109, a camera 110, and a short-range wireless communication unit 120.

The CPU 101 controls overall operations of the mobile terminal 11 by executing a program 114 stored in the flash ROM 104. The ROM 102 stores an IPL (initial program loader) and static data. The RAM 103 is used as a working area by the CPU 101 upon executing the program 114.

The flash ROM 104 stores programs to be executed by the CPU 101 including an OS (e.g., Android (registered trademark), iOS (registered trademark), or Windows (registered trademark)); middleware; and the program 114 for implementing functions of the mobile terminal 11 described below.

The FPD 105 may be a liquid crystal or organic EL (electroluminescence) display, or a projector, for example, and is configured to display a UI (user interface) screen. A graphic control unit (not shown) interprets a depiction command that is written on a video RAM by the CPU 101 and displays various items of information such as a window, a menu, a cursor, a character, or an image. The FPD 105 includes an integrated touch panel that displays soft keys for accepting a user operation, for example.

The operation unit 106 may include hard keys for accepting a user operation and/or soft keys displayed on the touch panel, for example. An operation of the hard key, the touch panel, or the soft key is communicated to the CPU 101. In one embodiment, the operation unit 106 may include a microphone (not shown) for implementing speech recognition, which involves converting sound into an electric signal and converting electric signal into text data, for example.

The media I/F 107 controls read/write operations on recording media such ash a flash memory.

The program 114 may be a file in a computer-installable format or computer-executable format. For example, the program 114 as a computer-installable file or a computer-executable file may be a downloaded from the server 12 to the mobile terminal 11. The program 114 may also be stored in a computer-readable storage medium and distributed.

The wireless LAN communication unit 108 transmits and receives data while controlling the modulation method, the transmission speed, frequency, and the like based on IEEE802.11b/11a/11g/11n. Upon receiving data, the wireless LAN communication unit 108 converts a received radio wave into a digital signal, and upon transmitting data, the wireless LAN communication unit 108 modulates data requested by the CPU 101 according to a communication standard and transmits the data as a radio wave.

The carrier communication unit 109 may establish various types of communication depending on the telecommunications carrier to which the user of the mobile terminal 11 subscribes. The telecommunications carrier may be a mobile telecommunications service provider that provides telecommunications services based on a communications standard such as CDMA or LTE, or a WiMax communications service provider, for example. The carrier communication unit 109 includes a SIM (subscriber identity module) card. The SIM card is an IC card storing subscriber information that is issued by the telecommunications carrier. The SIM card stores information items such as the so-called IMS (international mobile subscriber identity), which is a unique number assigned to the subscriber, and the mobile phone number, for example.

The carrier communication unit 109 performs modulation according to the communication system designated by the telecommunications carrier, and establishes communication with a base station connected to the Internet. The base station is connected to a server of the telecommunications carrier, and the server assigns a temporary IP address to the mobile terminal 11 to connect the mobile terminal 11 to an IP network via a router.

The camera 110 is a color imaging device including a photoelectric conversion element such as a digital charge-coupled devices (CCD) sensor or a complementary metal-oxide-semiconductor (CMOS) sensor. The camera 110 may be configured to capture a still image or a moving image, for example.

The short-range wireless communication unit 120 may be a communication unit conforming to the Near Field Communication (NFC) standard, for example. Although the short-range wireless communication unit 120 is capable of establishing bidirectional communication, the short-range wireless communication 120 is used in the present embodiment primarily to transmit a chip ID of the IC chip of the mobile terminal 11 to the POS register side. The short-range wireless communication unit 120 includes an internal antenna that is prompted to resonate with an electric wave that is received from the POS register and generate an electromotive force. The electric wave includes a control signal (command) for controlling the IC chip. The IC chip activates its circuit with the generated electric power (or battery power if a battery is provided) and performs a process according to the control signal (i.e., process of reading and transmitting the chip ID). The short-range wireless communication unit 120 may also use other wireless communication standards such as Bluetooth (registered trademark) or Ultra Wide Band (UWB), for example.

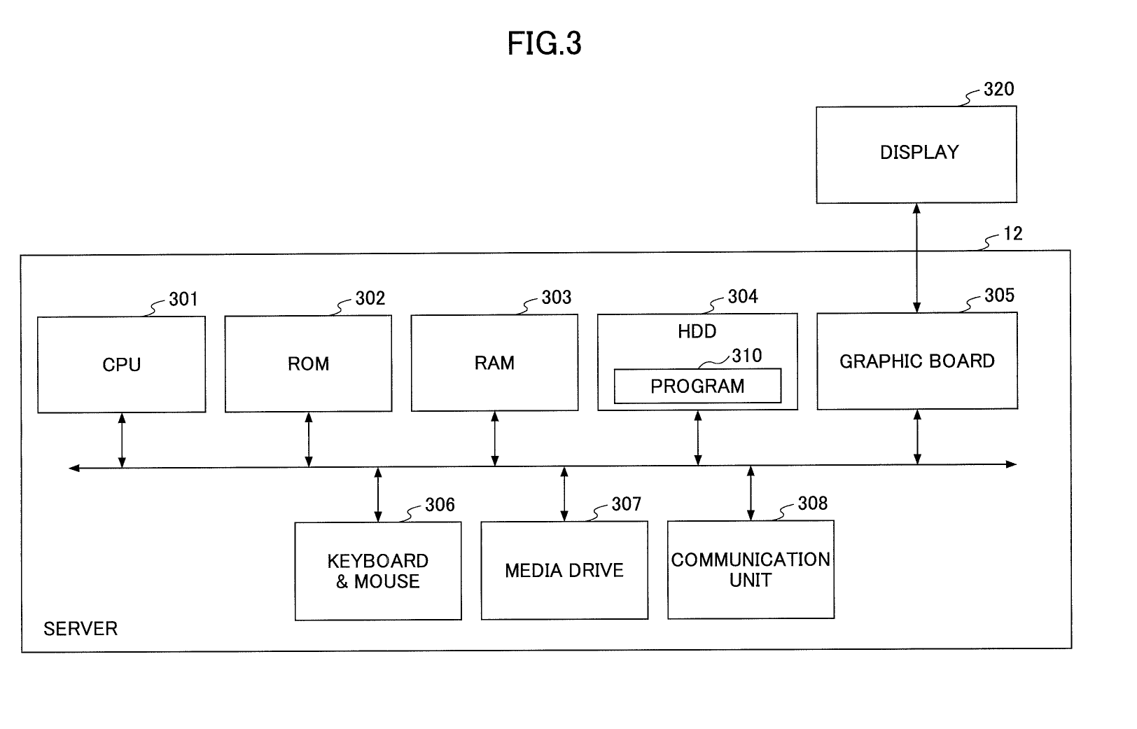

FIG. 3 is a block diagram illustrating an exemplary hardware configuration of the server 12. The server 12 may be a general-purpose information processing apparatus, for example.

The server 12 includes a CPU 301, a ROM 302, a RAM 303, a HDD 304, a graphic board 305 that is connected to a display 320, a keyboard & mouse 306, a media drive 307, and a communication unit 308. The CPU 301 executes a program stored in the HDD 304 using the RAM 303 as a working area to control overall operations of the server 12. The keyboard & mouse 306 are input devices that accept operations by a system administrator, for example. The media drive 307 reads/writes data from/on an optical medium such as CD, a DVD, or a Blu-ray disk. The communication unit 308 may be an Ethernet (registered trademark) card for establishing connection with a network.

The HDD 304 stores software such as an OS (e.g., Windows (registered trademark), Linux (registered trademark)), middleware, and a program 310 (described below) for implementing functions of the server 12. The program 310 may be a file in a computer-installable format or a computer-executable format. For example, the program 310 may be distributed in the form of a computer-installable or computer-executable file stored on a computer-readable medium. In another example, the program 310 may be distributed as a computer-installable or computer-executable file from a server (not shown).

The POS server 14 may have a hardware configuration of a general-purpose information processing apparatus similar to the hardware configuration of the server 12.

[In-Store Member Registration]

To use the payment system 200 of the present embodiment, a customer has to register as a member of the payment system 200 beforehand. The POS register 13 at the store is already registered with the payment system 200 and has a corresponding member store code and store name registered in the member store information DB. By having the customer register as a member, member data of the customer may be registered in the server 12. In the present embodiment, the IC chip of the mobile terminal 11 of the customer is used to register the member data of the customer.

The mobile terminal 11 may or may not have an IC chip installed therein. Because member registration may not be possible without an IC chip, in the case where an IC chip is not installed in the mobile terminal 11, a simple IC chip is preferably attached the mobile terminal 11. In this way, the customer may make a payment with a given credit card using his/her mobile terminal 11. Note that even if the mobile terminal 11 has an IC chip installed therein, the IC chip cannot be used by a customer in place of a credit card to make a payment unless the chip ID of the IC chip is registered in association with a corresponding member ID of the customer.

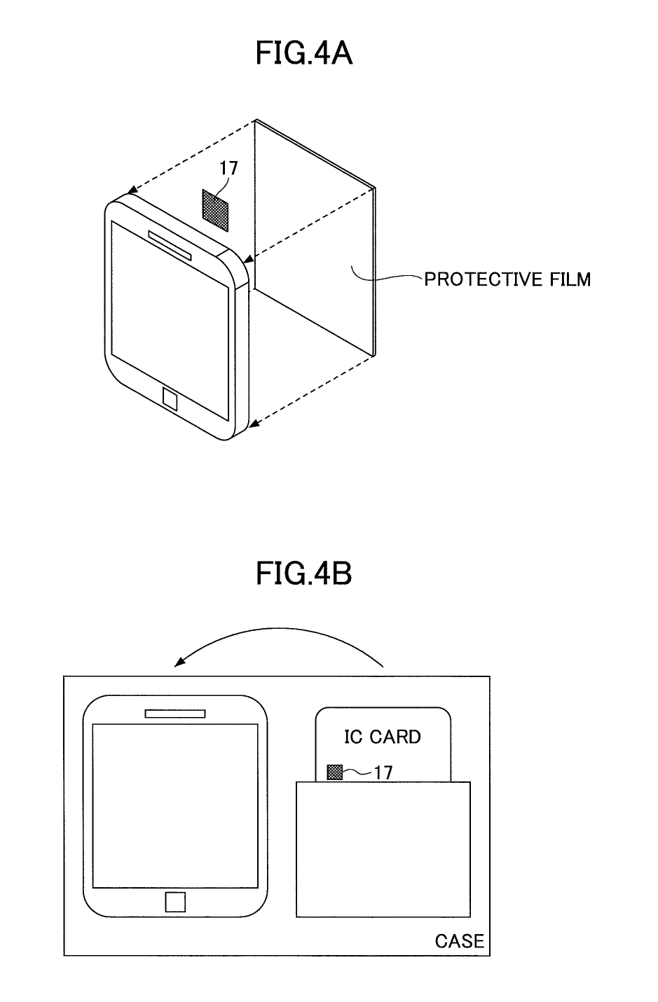

FIGS. 4A and 4B illustrate exemplary ways in which an IC chip 17 may be attached the mobile terminal 11. In FIG. 4A, the IC chip 17 is placed between the mobile terminal 11 and a protective film arranged on the rear face of the mobile terminal 11. Because the IC chip 17 including its antenna portion may be arranged to be substantially planar, the customer is not likely to feel any discomfort as a result of attaching the IC chip 17 to the mobile terminal 11.

In alternative examples, the IC chip 17 may be fixed to the mobile terminal 11 using an adhesive material such as a seal, or the chassis of the mobile terminal 11 may be opened and the IC chip 17 may be arranged inside the mobile terminal 11.

In FIG. 4B, an IC card including the IC chip 17 is accommodated inside a pocket of a case for the mobile terminal 11. The case may be a foldable case that protects the screen of the mobile terminal 11, for example. The IC card has the IC chip embedded therein. By having the IC card embody the IC chip 17 as in the present example, the customer may register with the payment system 200 using any IC card (i.e., any card including an IC chip) such as a FeliCa (registered trademark) card. In one example, the IC card may be a credit card including an IC chip.

In the example of FIG. 4A, the IC chip 17 attached to the mobile terminal 11 is associated with a member ID. In the example of FIG. 45, the IC chip 17 of the IC card is associated with the member ID. In the case where the IC card is a credit card including the IC chip 17, the customer may make a payment without presenting the credit card to the store clerk. Also, the customer may register any credit card or cash card with the payment system 200, not necessarily the credit card with the IC chip 17. In the case where the mobile terminal 11 has the IC chip 17 embedded therein, the embedded IC chip 17 is associated with the member ID.

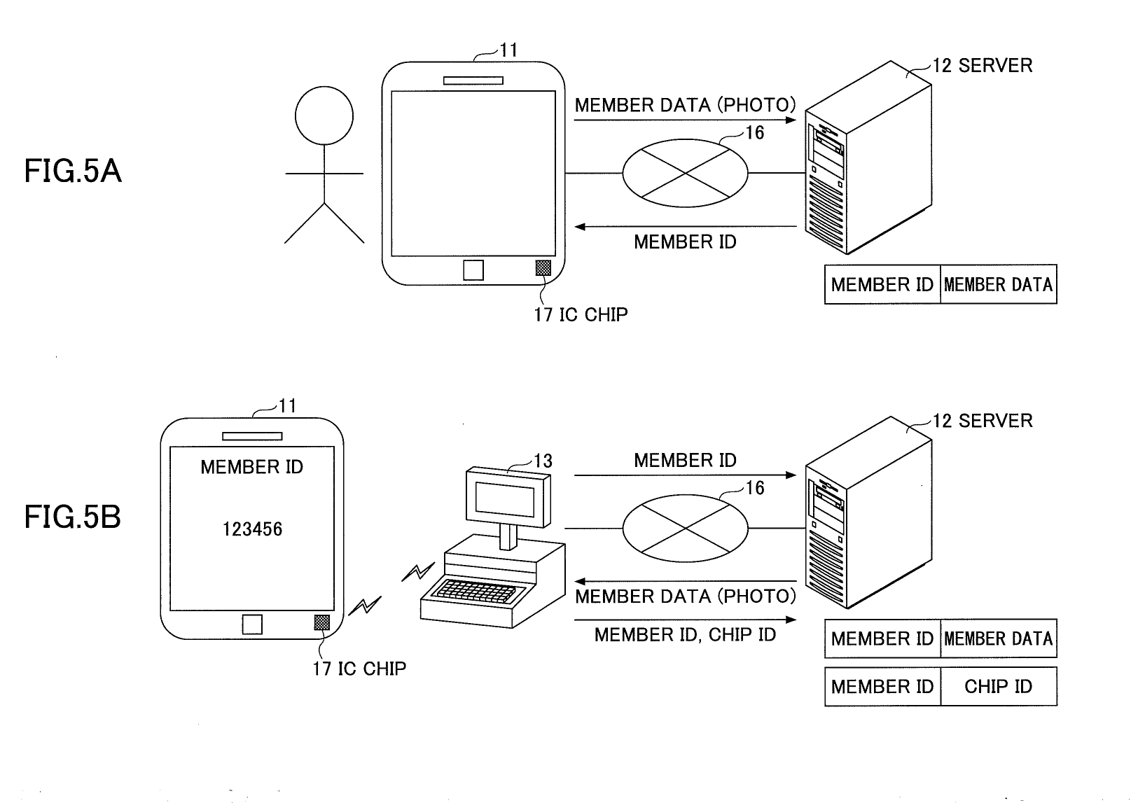

FIGS. 5A and 5B schematically illustrate exemplary procedures for registering member data. In the present embodiment, member data registration involves two stages.

(First Stage: FIG. 5A)

The customer connects the mobile terminal 11 to the server 12 and registers with the server 12 by inputting requisite items of information via the screen of the mobile terminal 11. In one example, a service such as RapiNAVI (registered trademark) may be used to establish connection with the server 12. The service such as RapiNAVI is connected to the POS register 13 and is configured to transmit information to the IC chip 17 attached to or embedded in the mobile terminal 11. The information from the service may be used to guide the mobile terminal to the target server 12 or enable the mobile terminal 11 to send an email to the server 12, for example. In an alternative example, instead of using such a service, the customer may search for the URL of the server 12 using a search engine to establish connection with the server 12.

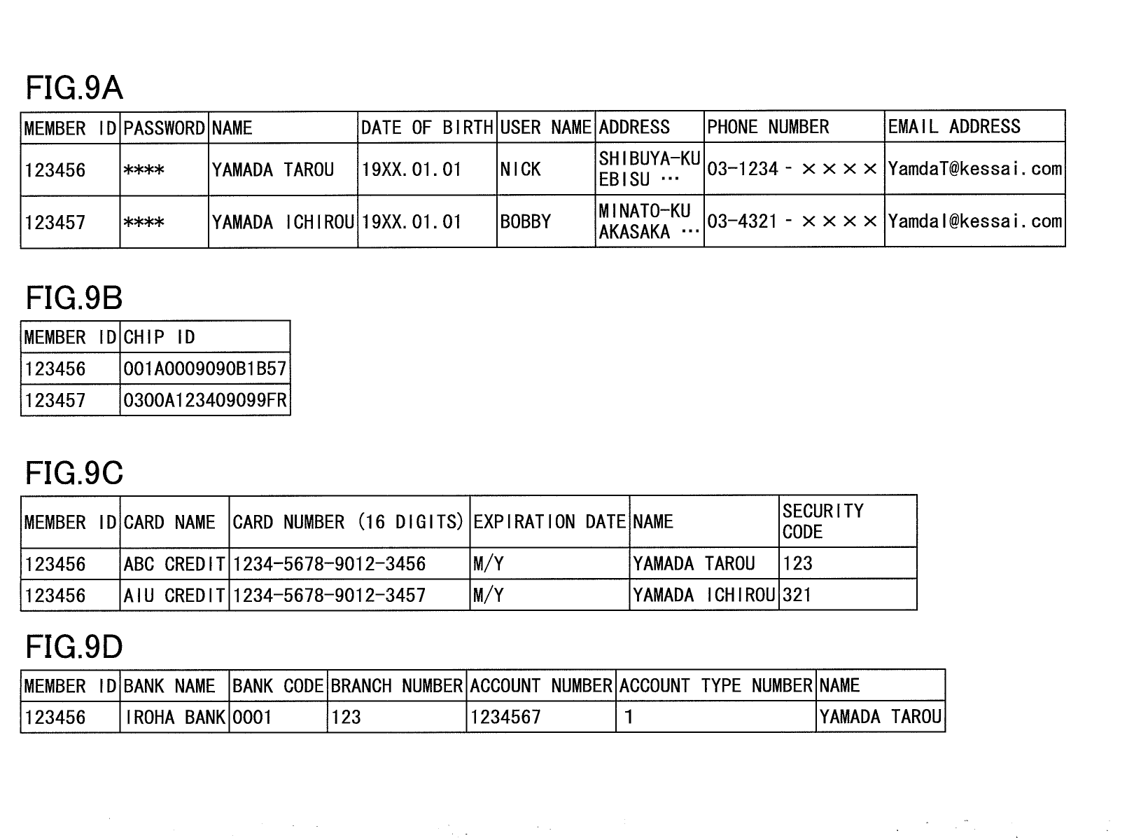

The requisite items of information to be registered may include personal information such as name, address, date of birth, user name, password, phone number, and email address. Such information is registered as member data. An exemplary data structure of the member data is illustrated in FIG. 9A. Also, as an option, a photograph of the customer may be registered as part of the member data.

The server 12 generates a unique member ID for the customer, and stores the member ID in association with the member data. The server 12 transmits the member ID to the mobile terminal 11 so that the mobile terminal 11 may store the member ID and display the member ID as is necessary. Also, once the customer is registered as a member, the mobile terminal 11 may access the server 12 and login to a personal account page of the customer to display the member ID.

(Second Stage: FIG. 5B)

Next, the customer registers the chip ID of the IC chip 17 in the server 12. First, the member ID is input to the DOS register 13 in the following manner and transmitted to the server 12.

(i) DOS register 13 scans the member ID displayed as a barcode by the mobile terminal 11.

(ii) Store clerk operates the DOS register 13 to input the member ID.

Because the DOS register 13 is connected to the server 12, the server 12 transmits the member data associated with the input member ID to the DOS register 13. In this way, the store clerk may check and verify the member data (name, date of birth, photo, etc.) with the customer to prevent an erroneous registration of some other person.

After such verification, the customer holds the mobile terminal 11 against a RFID reader of the POS register 13 and the RFID reader reads the chip ID of the IC chip 17 of the mobile terminal 11. Then, the member ID and the chip ID are transmitted to the server 12. In this way, the member ID and the chip ID may be registered in association with each other in the server 12.

By associating a given IC chip with a member ID in the manner described above, input operations at the POS register 13 side for enabling the purchase of an item by a registered customer may be completed by simply having the customer hold the mobile terminal 11 against the RFID reader of the POSE register 13, for example.

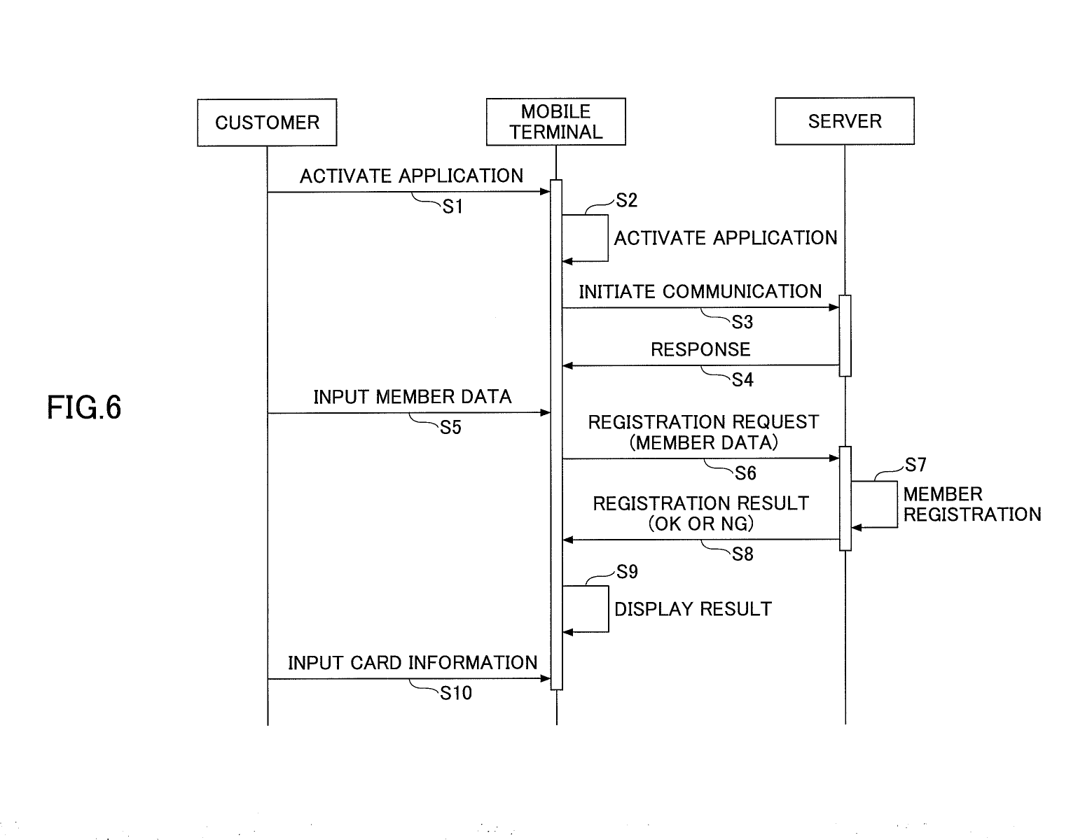

FIG. 6 is a sequence chart illustrating exemplary process steps of the first stage of the member registration process.

Step S1: The customer operates the mobile terminal 11 to activate an application. The application may be downloaded from the server 12 to be installed in the mobile terminal 11, for example. Note that the application cannot be used to purchase an item until member registration is completed.

Step S2: The mobile terminal 11 activates the application.

Step S3: The mobile terminal 11 initiates communication with the server 12. The IP address of the mobile terminal 11 may be a local IP address that is temporarily assigned to the mobile terminal 11 by the telecommunications carrier, or a fixed global IP address, for example. The IP address or URL of the server 12 is registered in the application.

Step S4: The server 12 responds to the communication initiated by the mobile terminal 11. In turn, the application detects that communication has been established between the mobile terminal 11 and the server 12 for enabling member registration. The application displays a screen for prompting the customer to input member data.

Step S5: The customer views the screen and enters the member data according to the screen.

Step S6: The mobile terminal 11 converts the accepted member data into an argument and transmits a registration request to the server 12.

Step S7: The server 12 generates a unique (non-duplicate) member ID and registers the member data in association with the generated member ID in the member DB.

Step S8: The server 12 transmits the member ID and a registration result to the mobile terminal 11. The registration result includes OK (registration successful) or NG (registration failed) as an argument.

Step S9: The mobile terminal 11 displays the registration result on the FPD 105. In this way, the customer may check whether member registration has been successful. Also, the application of the mobile terminal 11 stores the member ID so that the member ID may be displayed in response to a user operation.

Step S10: Thereafter, the customer inputs card information. The card information may include information of more than one card, and in this case, the customer may select the card to be used when making a payment. The card information does not have to be entered immediately after member registration as long as the card information is registered before the customer attempts to make a payment. The card information is retained by the application within the mobile terminal 11.

Although an application is used to perform member registration in the example illustrated in FIG. 6, in an alternative example, the customer may activate a browser and access a member registration page of the server 12 to perform the member registration.

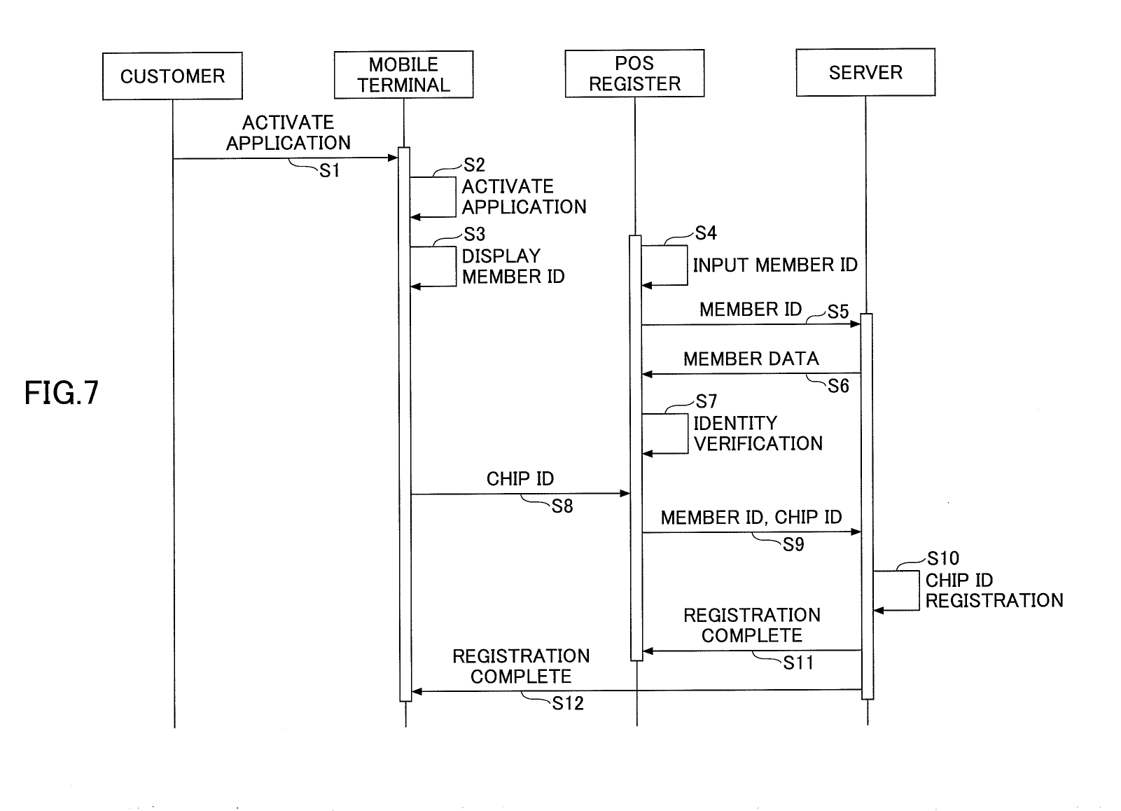

FIG. 7 is a sequence chart illustrating exemplary process steps of the second stage of the member registration process. The second stage of the member registration process may be performed at the time the customer is to purchase an item at the store, for example. Alternatively, the customer may come to the store where the POS register 13 is located solely for the purpose of completing the second stage of the member registration process.

Step S1: The customer operates the mobile terminal 11 to activate the application. Note, however, that the application does not necessarily have to be activated as long as the member ID may be input to the POS register 13.

Step S2: The mobile terminal 11 activates the application.

Step S3: Upon activating the application, the mobile terminal 11 displays the member ID either automatically or in response to an operation.

Step S4: The member ID is input to the POS register according to steps (i) and (ii) described above.

Step S5: The POS register 13 transmits the input member ID to the server 12.

Step S6: The server 12 reads the member data stored in the member DB using the member ID as a key and transmits the member data to the POS register 13.

Step S7: Then, identity verification of the customer is performed via the POS register 13. For example, the customer may be required to input information that is only known to the customer (e.g., date of birth) to the POS register 13 and the server 12 may determine the accuracy of the input information to verify the identity of the customer.

Step S8: After the identify verification is completed, the RFID reader of the POS register 13 reads the chip ID of the mobile terminal 11.

Step S9: The POS register 13 transmits the member ID and the chip ID to the server 12.

Step S10: The server 12 registers the chip ID in association with the member ID.

Step S11: The server 12 then sends a registration complete notification to the POS register 13.

Step S12: The application running on the mobile terminal 11 establishes connection with the IP address of the server 12 that is registered in the application beforehand and transmits the member ID of the mobile terminal 11 to the server 12. The server 12 identifies the mobile terminal 11 based on the member ID and transmits a registration complete notification to the mobile terminal 11.

[Payment for Purchase]

In the following, an exemplary payment made by the mobile terminal 11 executing the application in the payment system 200 of the present embodiment is described.

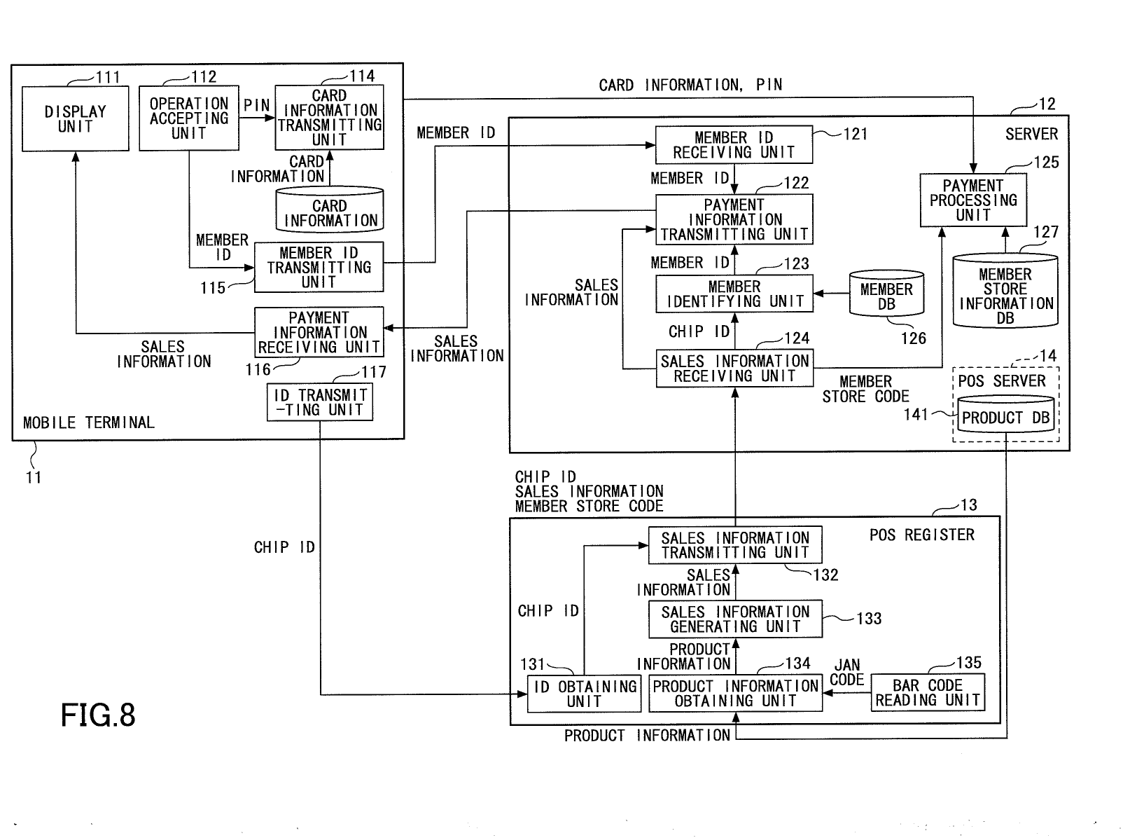

FIG. 8 is a block diagram illustrating functional features of the payment system 200 according to the present embodiment. First, data retained by the devices used in the payment system 200 are described.

<Server>

FIG. 9A illustrates an exemplary data structure of member data registered in the member DB. The member data includes personal information of members of the payment system 200. In FIG. 9, one record include the information items “member ID,” “password,” “name,” “date of birth,” “user name,” “address,” “phone number,” and “email address.”

The member ID may be a number, an alphabet, a symbol, or a combination thereof that unambiguously identifies a member of the payment system 200. The password may be a number, an alphabet, a symbol, or a combination thereof that is used by the server 12 to verify the customer. The name, date of birth, user name, address, phone number, and email, address are information items that are used by the payment system 200 to contact or identify a member.

FIG. 9B illustrates an exemplary data structure of a chip ID table that is registered in the member DB. The chip ID table includes the information items “member ID” and “chip ID.”

<Mobile Terminal>

The mobile terminal 11 stores card information of at least one card. The card information may include different items of information depending on whether the card information is that of a credit card or a bank card. FIG. 9C illustrates exemplary card information of a credit card. FIG. 9D illustrated exemplary card information of a bank card.

The card information of a credit card may include information items such as “member ID,” “card number,” “expiration date,” “name,” and “security code.” The card information of a bank card may include information items such as “member ID,” “bank name,” “bank code,” “branch number,” “account number,” “account type number,” and “name.” The bank code is a code for unambiguously identifying a bank or financial institution. The account type number is a number used to indicate the account type such as a checking account or a savings account. The card information is encrypted and the application is configured to decode the card information as is necessary.

<POS System>

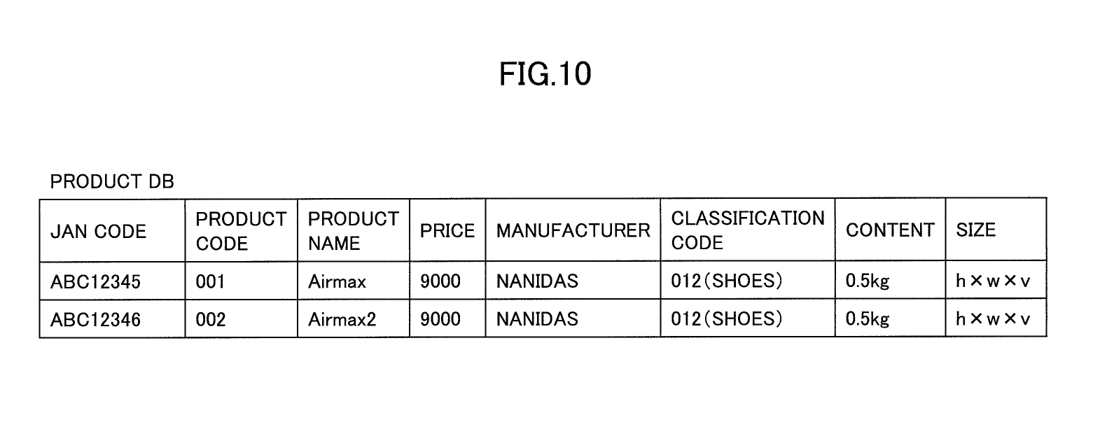

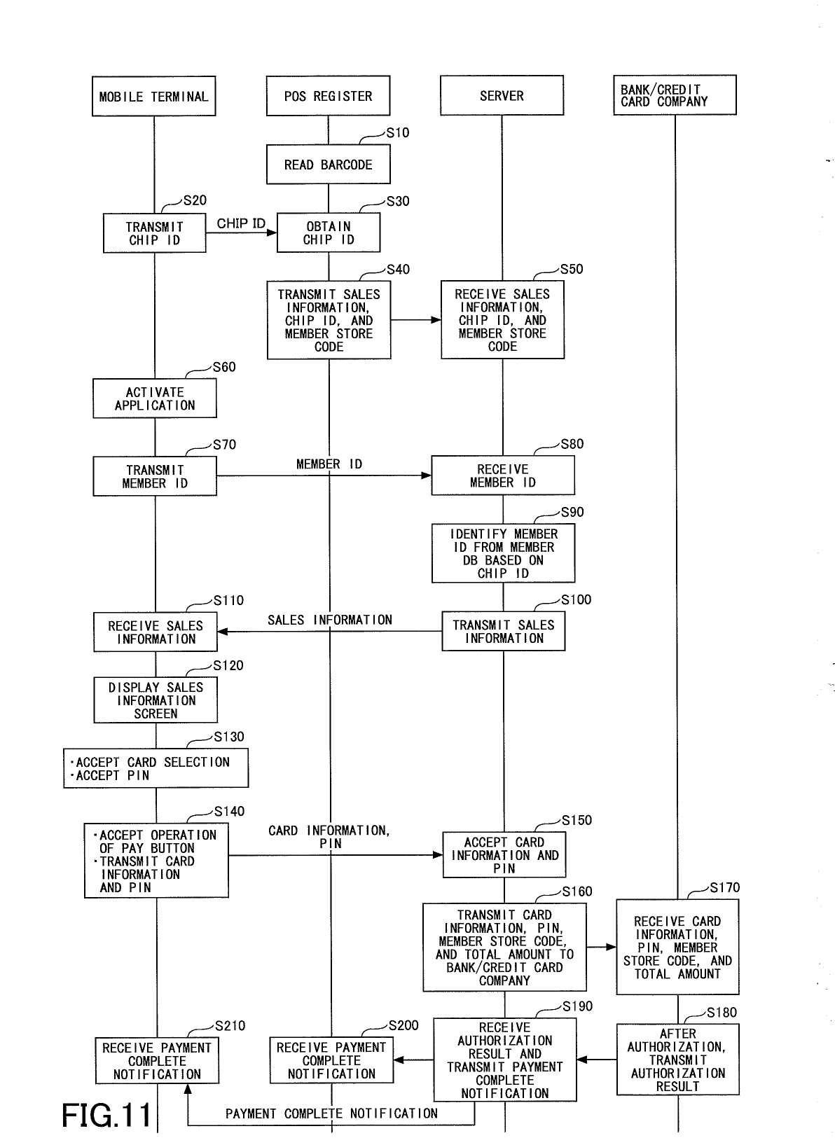

FIG. 10 illustrates an exemplary data structure of product data stored in a product DB 141 of the POS server 14. The product data may include information items such as “JAN code,” “product code,” “product name,” “price,” “manufacturer,” “classification code,” “content,” and “size.” The JAN (Japan Article Number) code is an 8-digit or 13-digit common product code that may be printed as a barcode on a tag that is attached to a product, for example. Although the JAN code is used in the example of FIG. 10, other types of code may used to unambiguously identify a product.

The JAN code enables unambiguous identification of a product, but the information managed by the JAN code may be arbitrarily determined by the operators of the POS system. Thus, FIG. 10 illustrates merely one exemplary manner of registering and managing product data.

The POS server 14 reads from the product DM 141 the product data associated with the JAN code received from the POS register 13, and transmits the product data to the POS register 13. In this way, the POS register 13 obtains information on the price of the product so that it may calculate a total amount and print a receipt, for example.

Referring back to FIG. 8, the mobile terminal 11 includes a display unit 111, an operation accepting unit 112, a card information transmitting unit 114, a member ID transmitting unit 115, a payment information receiving unit 116, and an ID transmitting unit 117. The ID transmitting unit 117 controls operations of the short-range wireless communication unit 120 to establish communication with the POS register 13 based on a wireless communication standard such as NFC and transmit the chip ID of the mobile terminal 11 to the POS register 13. The display unit 111 displays various screens. The operation accepting unit 112 accepts various operations by the customer including operations of the screen displayed by the display unit 11. For example, the display unit 111 and the operation accepting unit 112 may embody a payment approval accepting unit that displays payment information received from the server 12 and accepts a payment approval operation by the customer. The card information transmitting unit 114 transmits a PIN and card information to the server 12. The card information may be stored in the mobile terminal 11 beforehand, for example. The member ID transmitting unit 115 transmits a member ID to the server 12. The payment information receiving unit 116 receives sales information from the server 12. Note that although the card information is stored within the mobile terminal 11 in the illustrated example, the card information may alternatively be stored in a location that may be accessed by the mobile terminal 11 via a network, for example.

The POS register 13 includes an ID obtaining unit 131, a sales information transmitting unit 132, a sales information generating unit 133, a product information obtaining unit 134, and a barcode reading unit 135. The ID obtaining unit 131 may be a RFID reader, for example, that obtains a chip ID from the mobile terminal 11. The barcode reading unit 135 optically reads a barcode printed on a tag that is attached to a product and converts the read barcode data into a JAN code. The barcode reading unit 135 attaches information such as the sale date/time and store name to the JAN code and passes the JAN code to the product information obtaining unit 134. The product information obtaining unit 134 obtains product information from the POS server 14 using the JAN code as a key. The sales information generating unit 133 calculates a total amount by adding the price of the product information and generates sales information using the sales date/time, the stored name, and the product information. For example, the sales information may include the name and price of each purchased item, the purchase date/time, the store name, and the total amount. The sales information transmitting unit 132 transmits the sales information, the chip ID, and the member store code to the server 12.

The server 12 includes a member ID receiving unit 121, a payment information transmitting unit 122, a member identifying unit 123, a sales information receiving unit 124, a payment processing unit 125, a member DB 126, a member store DB 127, and the POS server 14. The member ID receiving unit 121 receives the member ID from the member ID transmitting unit 115. The sales information receiving unit 124 receives information including sales information from the POS register 13. The member identifying unit 123 refers to the member DB 126 and identifies a member ID that is associated with the chip ID received from the POS register 13. The payment information transmitting unit 122 is an embodiment of a sales information transmitting unit that associates the sales information from the POS register 13 with the mobile terminal 11 that has transmitted the member ID identified by the member identifying unit 123 and transmits the sales information to the mobile terminal 11.

The payment processing unit 125 receives card information and a PIN from the mobile terminal 11 and transmits the received information to a bank/credit card company. Thereafter, conventional payment processing procedures may be implemented at the bank/credit card company. After the payment processing procedures are completed, the payment processing unit 125 transmits a payment complete notification to the mobile terminal 11 and the POS register 13. The POS server 14 includes the product DB 141 and provides product information to the POS register 13. Although the POS server 14 is included in the server 12, the POS server 14 may be located anywhere that can be accessed by the POS register 13.

[Payment System Operations]

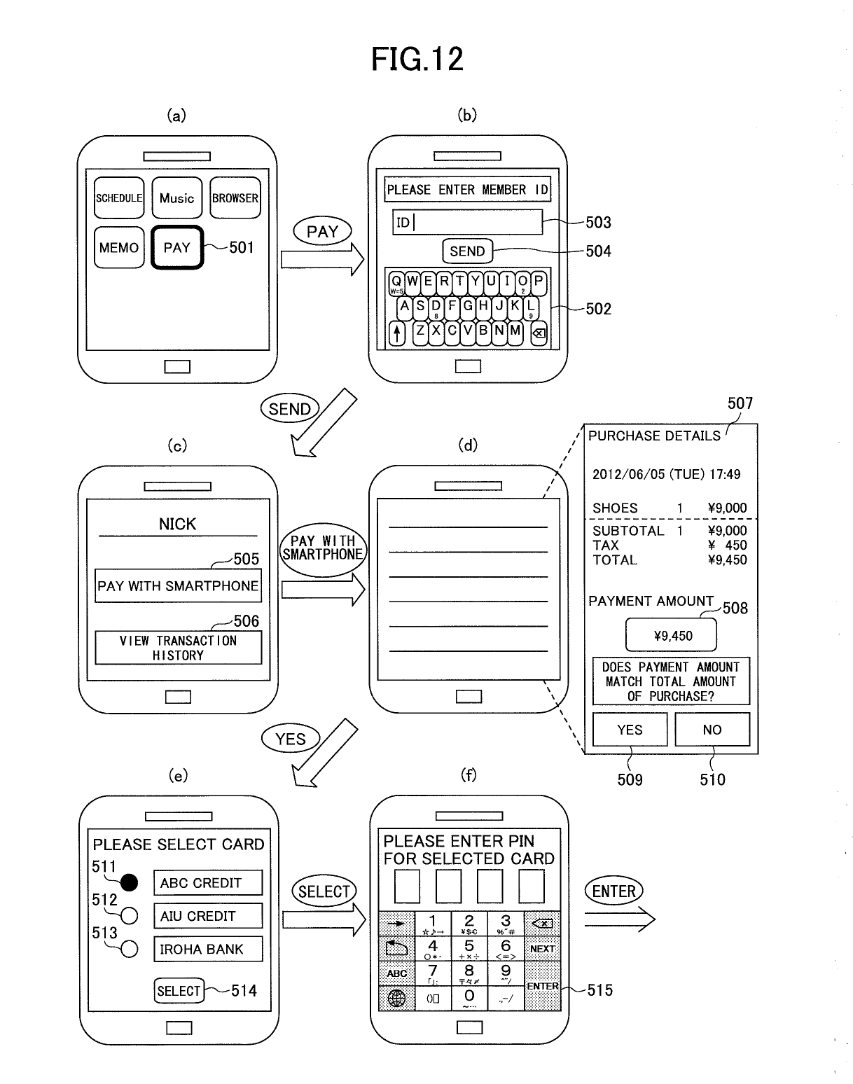

FIG. 11 is a flowchart illustrating exemplary operations of the payment system 200 upon purchasing a product. Process steps of FIG. 11 are described with reference to exemplary screens illustrated in FIGS. 12-15B.

In step S10, the customer carries a desired product to the POS register 13 and hands the product to the store clerk (cashier). The store clerk has the barcode reading unit 135 read the barcode attached to the product and convert the barcode into a JAN code.

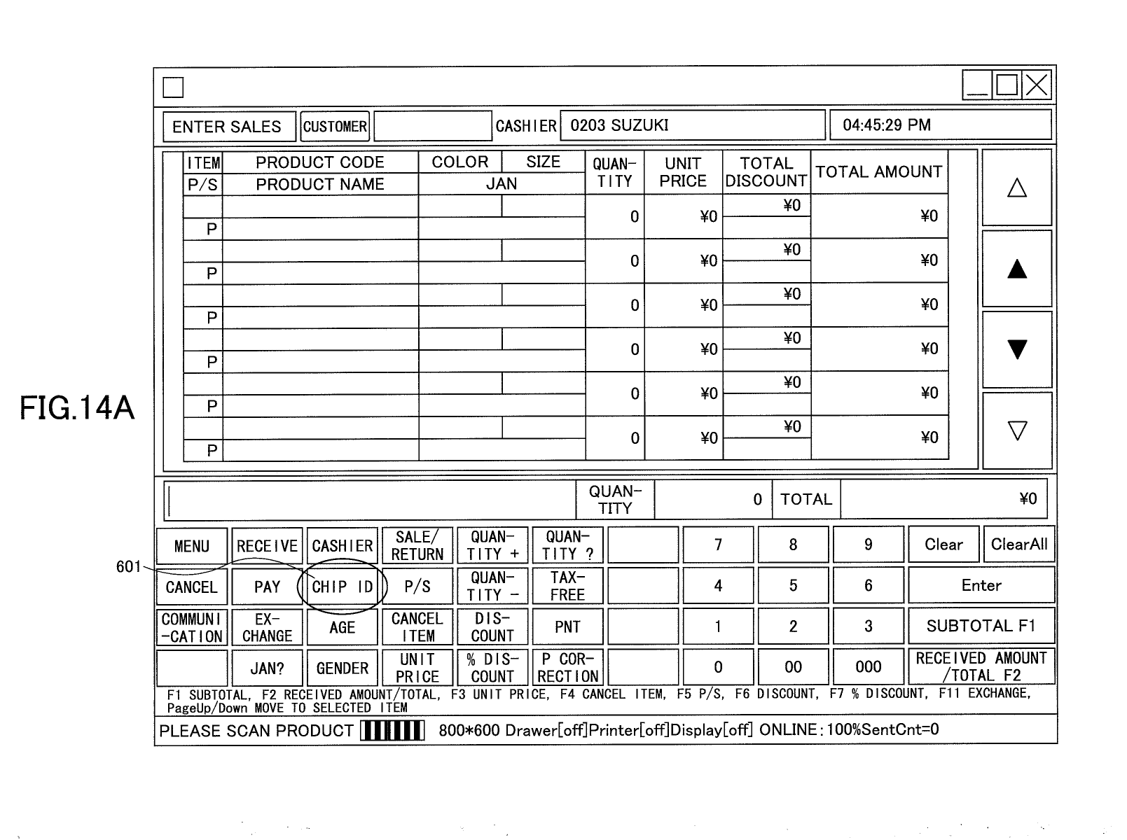

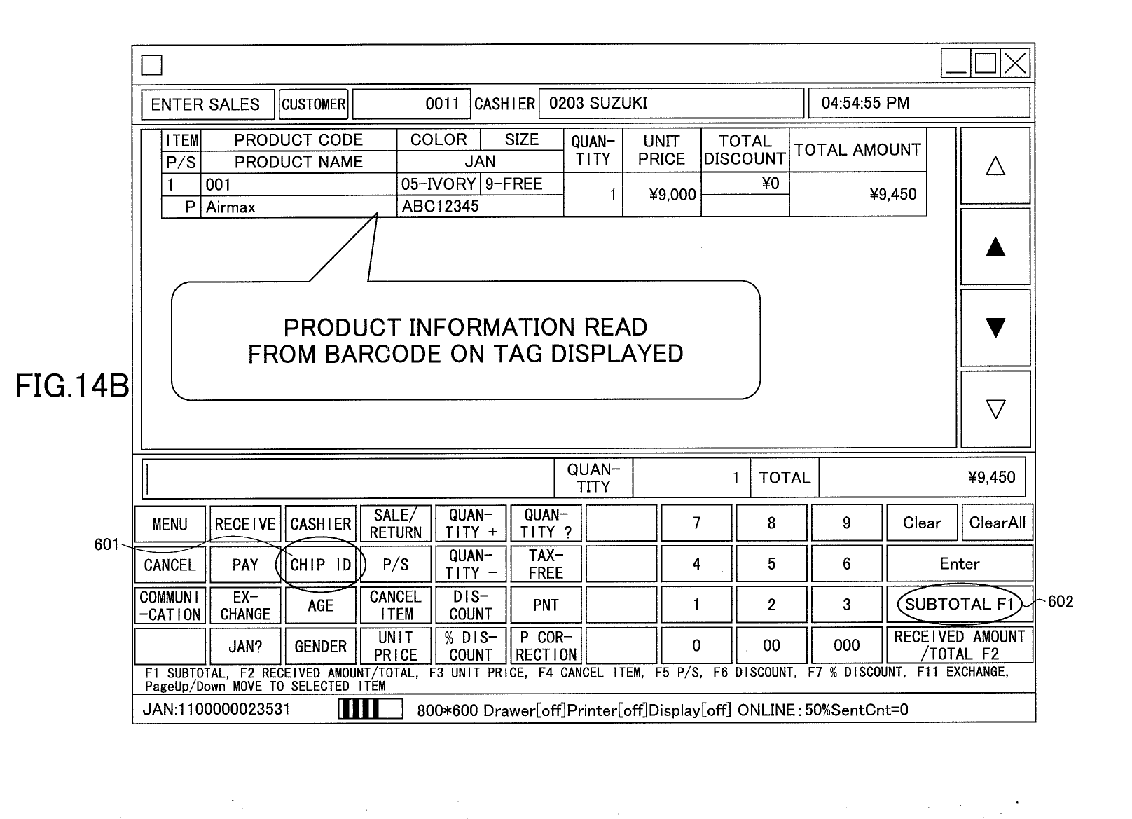

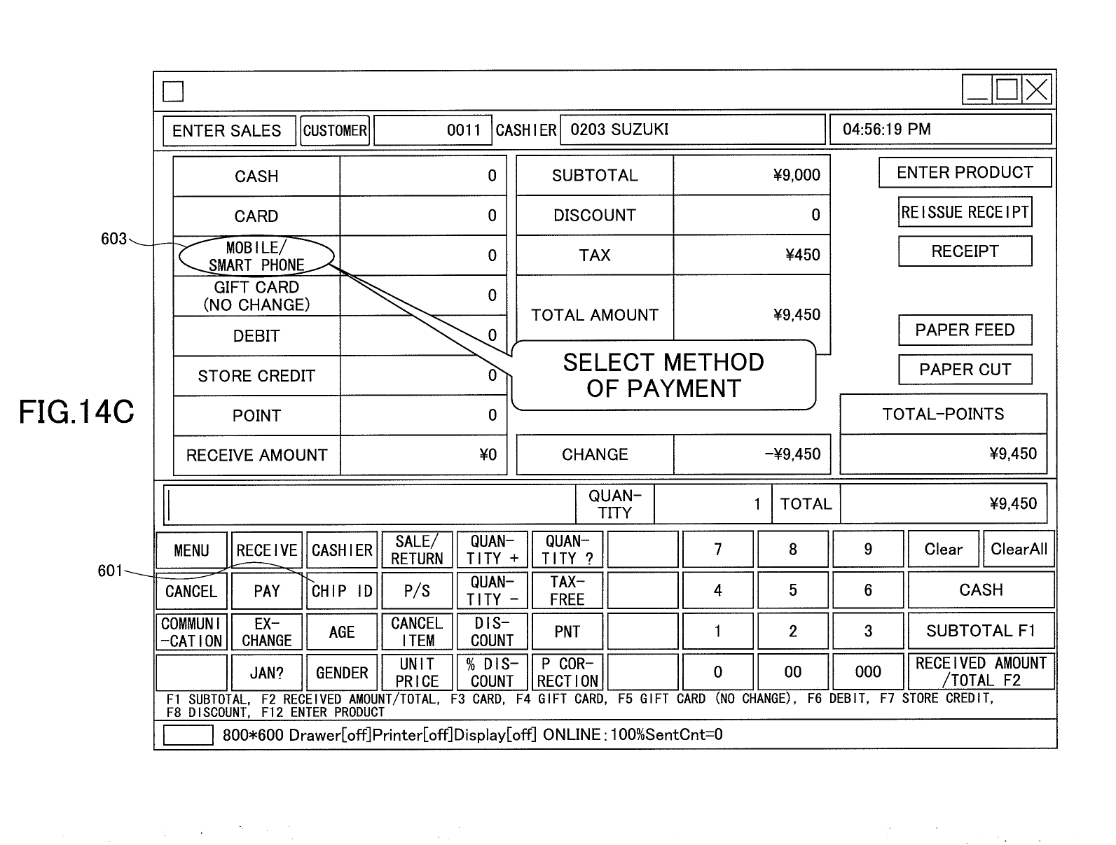

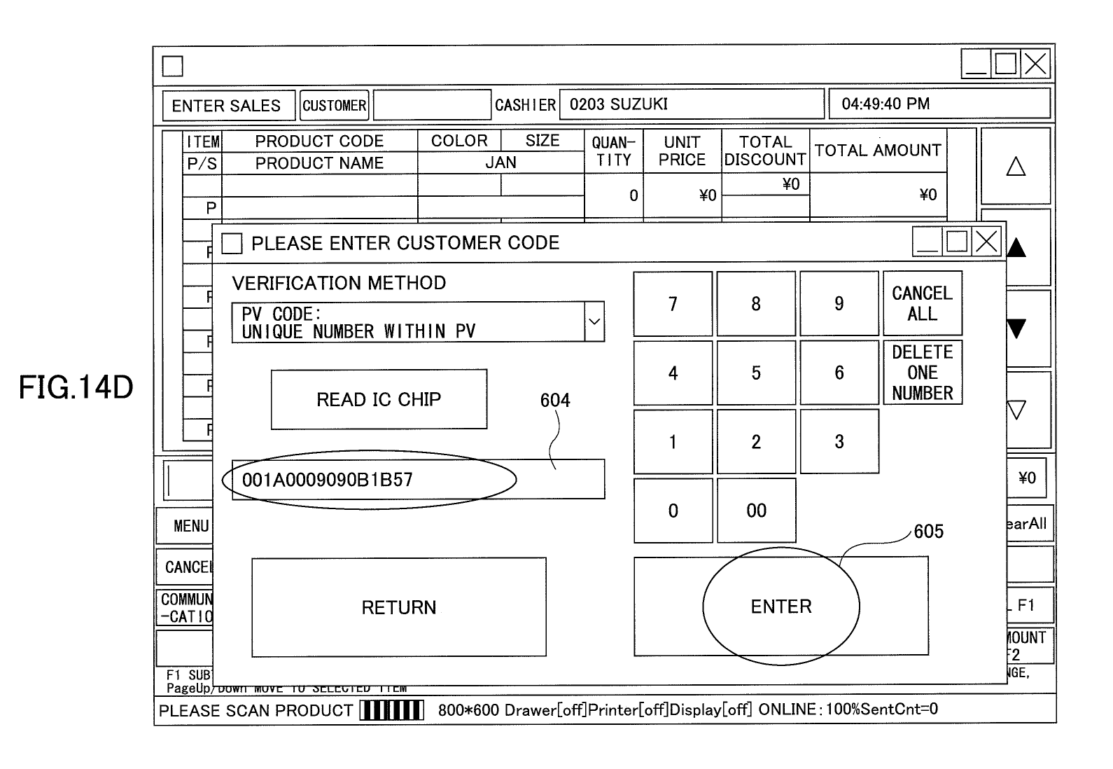

The product information obtaining unit 134 transmits the JAN code read by the barcode reading unit 135 to the POS server 14 and obtains product data from the POS server 14. The sales information generating unit 133 calculates the total price of all the products to be purchased (see FIGS. 14A and 14B).

In step S20, when the customer holds the mobile terminal 11 close to the RFID reader (ID obtaining unit 131) of the POS register 13, the ID transmitting unit 117 transmits the chip ID of the mobile terminal 11 to the POS register 13.

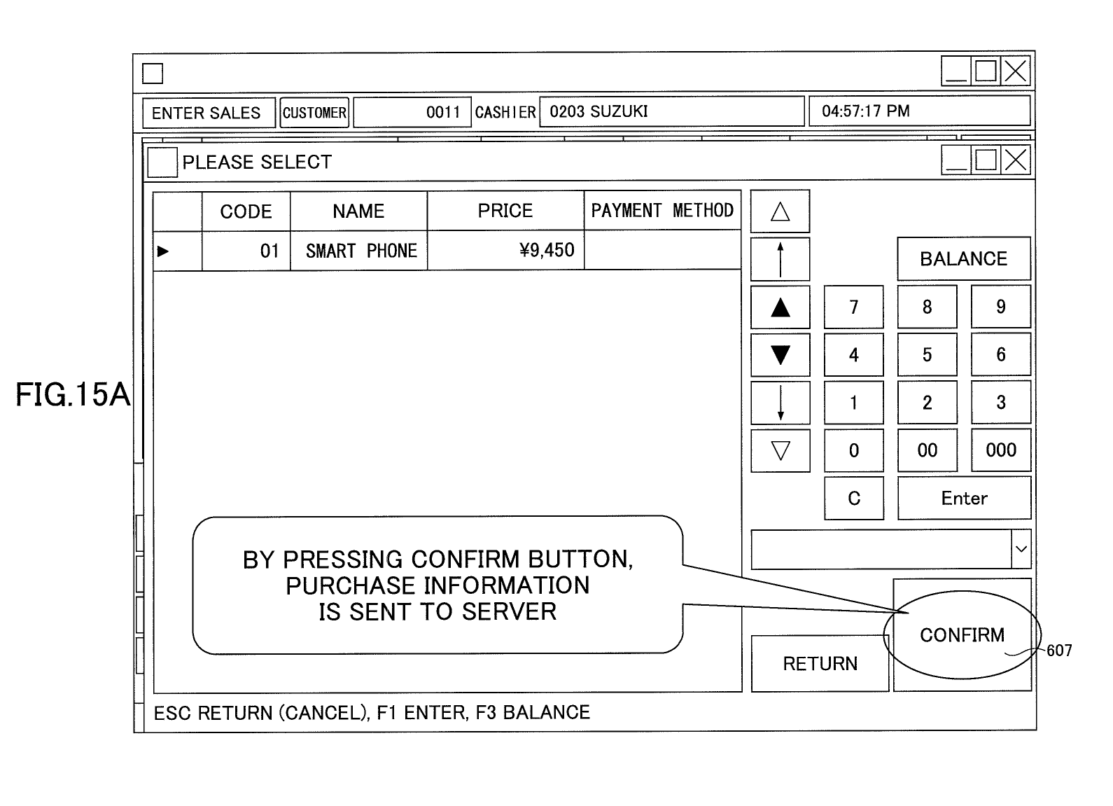

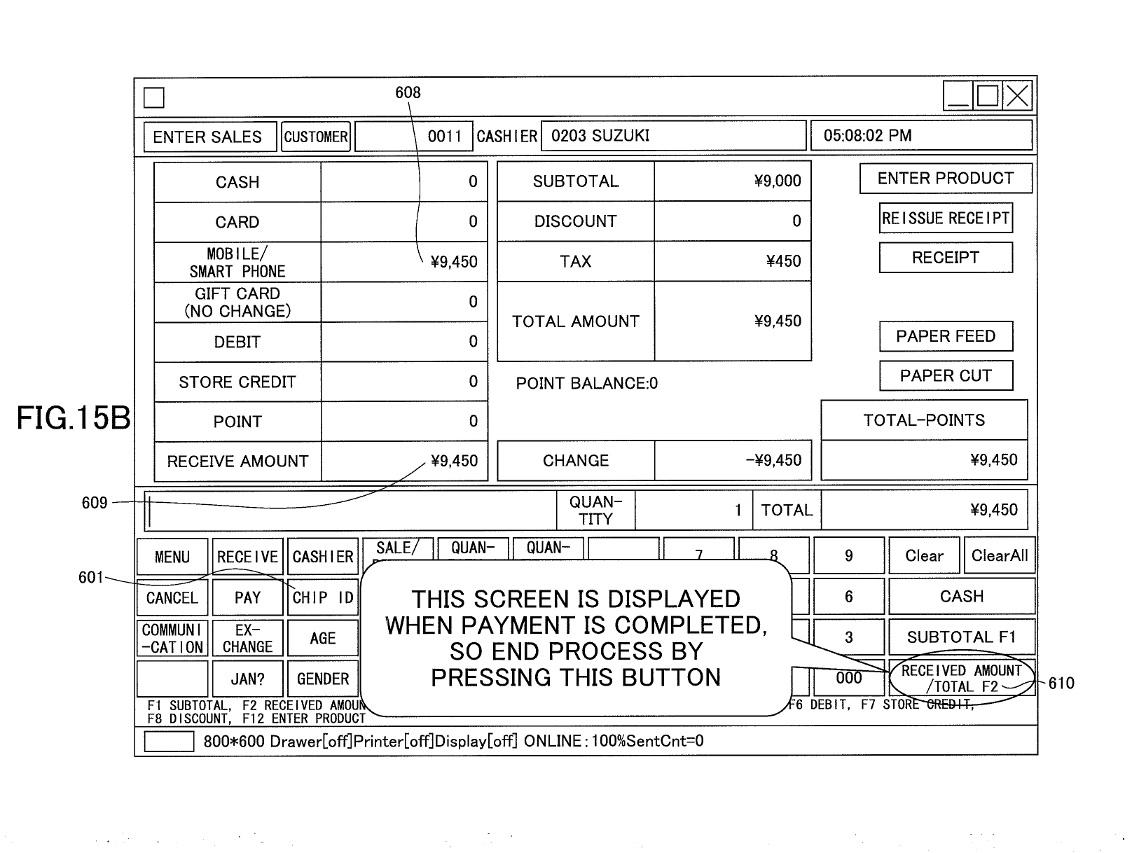

In step S30, the ID obtaining unit 131 of the POS register 13 obtains the chip ID (see FIGS. 14C, 14D, and 15A).

In step S40, the sales information transmitting unit 132 of the POS register 13 transmits the chip ID, sales information, and member store code to the server 12.

In step S50, the sales information receiving unit 124 of the server 12 receives the chip ID, sales information, and member store code.

In step S60, the customer activates the application after or before carrying the product to the POS register 13 (see FIG. 12(a)). By activating the application, the mobile terminal 11 may display the member ID stored in the mobile terminal 11 or enable the customer to input information and operation commands, for example (see FIG. 12(c)).

In step S70, when the operation accepting unit 112 of the mobile terminal 11 accepts an operation by the customer, the member ID transmitting unit 115 transmits the member ID to the server 12.

In step S80, the member ID accepting unit 121 of the server 12 receives the member ID.

In step S90, the member identifying unit 123 of the server 12 identifies the member ID associated with the received chip ID by referring to the member DB 126. Thereafter, the server 12 may transmit the corresponding member data of the member ID to the mobile terminal 11 (see FIG. 12(c)).

In step S100, when the customer proceeds with the payment procedure and selects a “Pay with Smartphone” button 505 in FIG. 12(c), for example, the payment information transmitting unit 122 of the server 12 transmits the sales information to the mobile terminal 11 that has transmitted the member ID identified by the member identifying unit 123.

In step S110, the payment information receiving unit 116 of the mobile terminal 11 receives the payment information.

In step S120, when the sales information is received, the display unit 111 of the mobile terminal 11 displays a sales information screen. In this way, the operation accepting unit 112 of the mobile terminal 11 may accept the operation of a “YES” button 509 or a “NO” button 510 by the customer (see FIG. 12(d)).

In step S130, the operation accepting unit 112 accepts a card selection input operation and a PIN input operation by the customer (see FIG. 12 (e) and (f)). When the PIN is input, the mobile terminal 11 temporarily stores the PIN.

In step S140, upon accepting the operation of a “PAY” button 516 (see FIG. 13 (a) and (b)), the card information transmitting unit 114 transmits the card information and PIN to the server 12. In step S150, the payment processing unit 125 of the server 12 receives the card information and the PIN.

Thereafter, normal authorization procedures may be implemented. Specifically, in step S160, the payment processing unit 125 of the server 12 transmits the card information, PIN, member store information associated with the member store code, and the total amount to a ban/credit card company.

In step S170, the bank/credit card company receives the card information, PIN, total amount, and member store information.

In step S180, after authorization, the bank/credit card company transmits the authorization result to the server 12.

In step S190, the server 12 receives the authorization result and transmits a payment complete notification to the POS register 13 and the mobile terminal 11.

In step S200, the POS register 13 receives the payment complete notification (see FIG. 15B). In step S210, the mobile terminal 11 receives the payment complete notification (see FIG. 13(c)).

As can be appreciated from above, in the payment system 200 according to the present embodiment, payment with a credit card or a bank card may be made without requiring the customer to provide card information to the POS register 13 or the store even at the time of member registration. Also, the customer does not need to carry his/her credit card or bank card.

Further, in the application-type payment system 200 of the present embodiment, the card information is stored in the mobile terminal 11 so that the customer may retain control over his/her card information. Thus, even customers that are reluctant to allow his/her card information to be stored somewhere beyond the customer's control may feel secure using the payment system 200 of the present embodiment.

[Screen Transition Examples]

FIGS. 12 and 13 illustrate exemplary screen transitions of the mobile terminal 11.

FIG. 12(a) illustrates an exemplary standby screen of the mobile terminal 11. The standby screen displays an application icon 501 for the payment system 200. The customer may activate the application by tapping the application icon 501, for example.

FIG. 12(b) illustrates an exemplary ID input screen that is displayed when the application is activated. The ID input screen displays a message “Please enter member ID,” soft keys 502, an ID input field 503, and a “SEND” button 504. The customer is prompted to input a member ID in the ID input field 503 using the soft keys 502. Alternatively, the member ID may be stored in the mobile terminal 11.

When the customer presses the “SEND” button 504, the mobile terminal 11 transmits the input member ID to the server 12.

Then, the mobile terminal 11 displays a waiting screen while the server 12 identifies the customer based on the member ID. The server 12 then transmits information such as the name and user name corresponding to the member ID. Upon establishing communication with the server 12, the mobile terminal 11 may display a next screen.

FIG. 12(c) illustrates an exemplary process selection screen that is displayed after the mobile terminal 11 establishes communication with the server 12. The illustrated process selection screen displays a “Pay with Smartphone” button 505 and a “View Transaction. History” button 506. To make a payment, the customer selects the “Pay with Smartphone” button 505 in response to which the mobile terminal 11 transitions to a next screen. When the “Pay with Smartphone” button 505 is pressed (or before such operation), the mobile terminal 11 receives the sale information from the server 12.

FIG. 12(d) illustrates an exemplary sales information screen. The illustrated sales information screen displays purchase details 507, a payment amount (“§9,450”) 508, a “YES” button 509, and a “NO” button 510. The customer is prompted to compare the total amount of purchase displayed at the POS register 13 at the store with the payment amount 508 and press either the “YES” button 509 or the “NO” button 510. The application accepts the operation (pressing) of the “YES” button 509 by the customer as a payment operation.

FIG. 12(e) illustrates an exemplary card selection screen. The card selection screen displays card information of cards that have been stored in the mobile terminal 11 through prior operation of the application by the customer. The customer may select a card to be used in the present transaction by selecting one of toggle buttons 511-513 and pressing a “SELECT” button 514.

FIG. 12(f) illustrates an exemplary PIN input screen. The customer is prompted to input the PIN for the selected card using soft keys 515. When the customer presses the “ENTER” key of the soft keys 515, the mobile terminal 11 displays a final payment screen.

FIG. 13(a) illustrates an exemplary final payment screen. The illustrated final payment screen displays a message “Do you wish to send payment data and complete payment?” a “PAY” button 516, and a “RETURN” button 517. The “PAY” button 516 is for accepting a final confirmation of the customer's wish to proceed with the payment. The customer may press the “PAY” button 516 if the customer still wishes to proceed with the payment. When the “PAY” button 516 is pressed, the mobile terminal 11 transmits the card information and PIN to the server 12. In turn, the server 12 transmits the card information to the bank/credit card company. At this time, the mobile terminal 11 displays a waiting screen.

FIG. 13(b) illustrates an exemplary waiting screen that is displayed after the “PAY” button 516 is pressed and the mobile terminal 11 transmits the card information and PIN to the server 12. The bank/credit card receiving the card information from the server 12 performs authorization procedures with respect to the customer based on the card information and transmits a payment complete notification (positive authorization result) to the server 12 if the authorization is approved. Upon receiving the payment complete notification from the bank/credit card company, the server 12 transmits the payment complete notification to the POS register 13 and the mobile terminal 11. Upon receiving the payment complete notification from the server 12, the mobile terminal 11 displays a payment complete screen.

FIG. 13(c) illustrates an exemplary payment complete screen. The illustrated payment complete screen displays a payment complete message 517, purchase details 518, and a payment method 519.

FIGS. 14A-15B illustrate exemplary screen transitions of the POS register 13.

FIG. 14A illustrates an exemplary initial screen of the POS register 13. The initial screen displays a number of soft keys including a chip ID read button 601 for enabling the POS register 13 to read and accept a chip ID input.

FIG. 14B illustrates an exemplary product information screen. The store clerk (cashier) uses a scanner to read a barcode (JAN code) printed on a tag that is attached to a product to be purchased by the customer. In this way, the POS register 13 may display product information that is stored in association with the JAN code in the product DB 141 such as the product code, product name, color, size, and unit price. In the case where more than one product is purchased, a total price may be calculated. To calculate the total price, the store clerk may press a “SUBTOTAL” button 602 after reading the barcodes of all the products to be purchased.

FIG. 14C illustrates an exemplary payment method selection screen. The illustrated payment selection screen displays buttons for selecting a number of payment methods including “Cash,” “Card,” “Mobile/Smart Phone,” “Gift Card,” and “Debit.” After confirming the customer's desired method of payment, the store clerk (cashier) may press the “Mobile/Smart Phone” button 603, for example. Also, the store clerk may press the chip ID read button 601 to enable the POS register 13 to read a chip ID.

FIG. 14D illustrates an exemplary chip ID read result display screen. When the customer holds his/her mobile terminal 11 near the RFID reader (ID obtaining unit 131) of the POS register 13, the POS register 13 reads the chip ID of the IC chip of the mobile terminal 11 and displays the read chip ID at a chip ID field 604. In certain preferred embodiments, for security purposes, only a portion of the chip ID may be displayed and the remaining portion may be replaced by the symbol “*”, for example. When the chip ID is displayed at the chip ID field 604, the store clerk may press an “ENTER” button 605.

FIG. 15A illustrates an exemplary payment method confirmation screen. In the illustrated payment method confirmation screen, the payment method selected at the payment method selection screen of FIG. 14C is displayed. When the store clerk presses a “CONFIRM” button 607, the POS register 13 transmits the chip ID, sales information, and member store code to the server 12. Thereafter, the POS register 13 may receive the payment complete notification from the bank/credit card company via the server 12.

FIG. 15B illustrates an exemplary payment complete screen displayed at the POS register 13. The illustrated payment complete screen displays the amount paid at a mobile/smart phone field 608 and the total amount at a received amount field 609. By checking this payment complete screen, the store clerk may confirm that the payment has been made with the mobile/smart phone (mobile terminal 11). The store clerk may then press a “RECEIVED AMOUNT/TOTAL” button 610 to end the payment process.

Note that the above-described screens are merely examples and other numerous designs may be implemented.

### Second Embodiment

in the first embodiment described above, the payment system 200 is used in a case where the customer makes a payment at a physical store. In a second embodiment of the present invention, the payment system 200 enables the customer to make a payment at any location such as when purchasing an item at an online store.

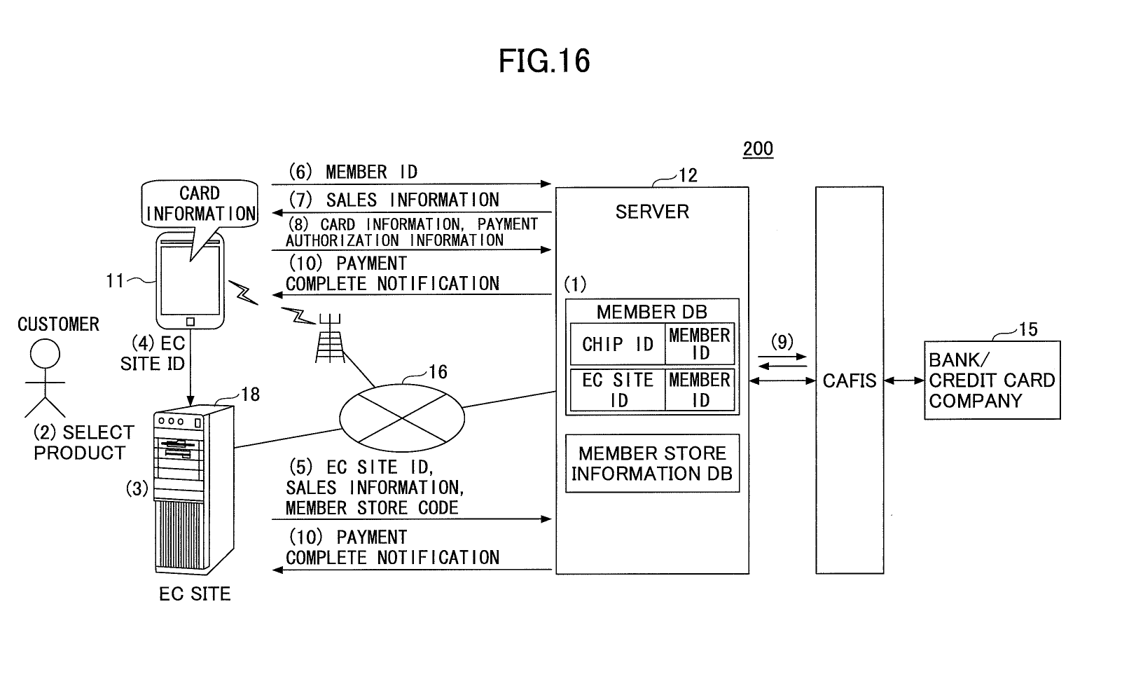

FIG. 16 schematically illustrates exemplary transaction procedures of the payment system 200 according to the present embodiment. In the payment system 200 according to the present embodiment, the POS register 13 of the first embodiment is replaced by an EC (electronic commerce) site 18.

(1) The customer is registered as a member in the server 12 beforehand. The customer is assigned an ID within the EC site (referred to as “EC site ID” hereinafter) and the EC site ID is registered in association with a member ID of the customer in the server 12. The member ID used in the present embodiment may be identical to that used in the first embodiment.

The EC site ID corresponds to identification information for identifying a member of the EC site within the EC site. For example, the EC site ID may be a login ID for enabling a member to login to the EC site such as a Yahoo ID. Because each EC site may assign a different BC site ID to its member, plural EC site IDs may be registered in association with a given member ID in the server 12. That is, the payment system 200 uses a chip ID to identify a member that is shopping at a physical store, and uses an EC site ID to identify a member that is shopping online.

The EC site ID may be registered using an application or a browser, for example. The mobile terminal 11 may access the server 12, and after being identified by its member ID, the mobile terminal 11 may transmit the EC site ID to the server 12 for registration.

(2) The customer accesses the EC site 18 to which the customer is a member and has the EC site ID registered with the server 12. The customer then selects a desired product at the EC site 18.

(3) In response to the product selection, product information of the selected product is obtained, a total amount is calculated, and sales information including the total amount and the product information is generated.

(4) Then, in the present embodiment, the mobile terminal 11 logs into the EC site 18 and transmits the EC site ID to the EC site 18. Note that the EC site ID may be transmitted before the product selection as well.

(5) The EC site 18 transmits the EC site ID and the sales information together with a member store code of the EC site 18 to the server 12.

Then, process steps similar to those of the first embodiment may be implemented to complete the purchase of the product.

In the present embodiment, the purchase of the product may be made by accessing the EC site 18 using a browser activated by the mobile terminal 11 or by accessing the EC site 18 using a browser activated by a general-purpose PC (personal computer), for example.

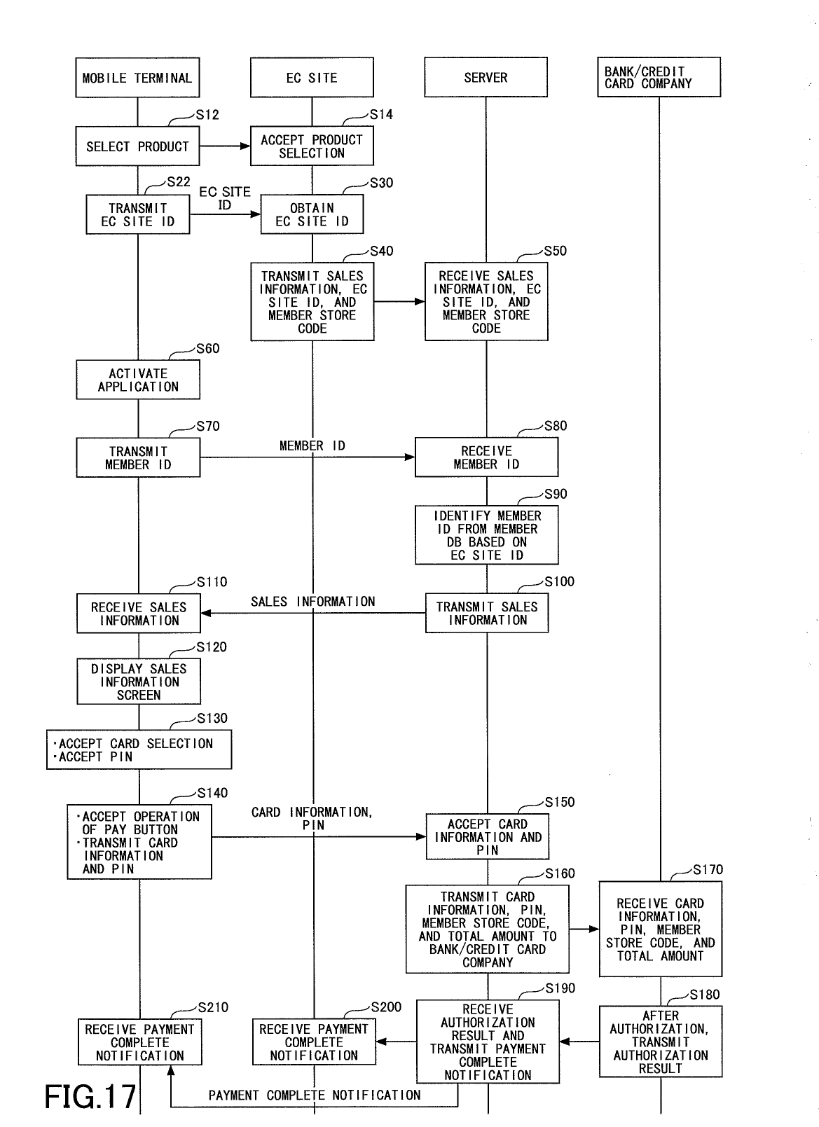

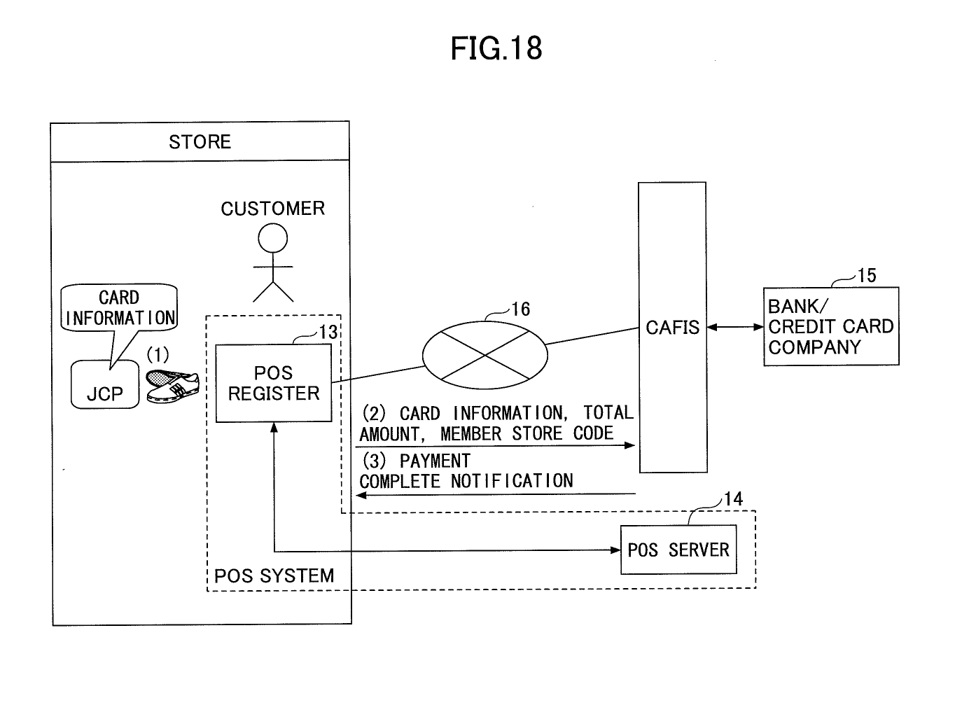

FIG. 17 is a flowchart illustrating exemplary operations of the payment system 200 of the present embodiment for enabling the purchase of a product.

In step S12, the customer operates the mobile terminal 11 or a PC to access the EC site 18 and selects a desired product. In step S14, the EC site 18 accepts the product selection. The software operating on the mobile terminal 11 or PC may be any browser for enabling access to the EC site 18. In step S22, the EC site ID of the customer is transmitted from the mobile terminal 11 or PC to the EC site 18 when the customer logs into the EC site 18.

In step S32, the EC site 18 receives the EC site ID and retains the EC site ID in association with the selected product. The customer selects to make a payment using a smartphone as a payment method. In turn, the EC site 18 starts process operations for enabling payment by such payment method. That is, in step S40, the EC site 18 transmits the EC site ID, and member store code to the server 12.

In step S60, the customer activates the application of the mobile terminal 11 to make a payment for the purchase of the product. The customer may activate the application after selecting the product or before the selection. Then, in step S70, the customer operates the mobile terminal 11 to transmit the member ID to the EC site 18. In step S80, the EC site 18 receives the member ID. The application of the mobile terminal 11 may include a browser function, and in this case, the customer may operate the application to access the EC site 18 and log into the EC site 18 to transmit the EC site ID to the EC site 18. Also, in this case, after selecting a product using the application, the customer may proceed to the step of transmitting the member ID without switching software applications.

Thereafter, process steps similar to those of the first embodiment may be implemented to complete the transaction. Unlike the case of making a payment at a physical store, the customer does not necessarily have to complete the payment process right away. However, the server 12 may be configured to cancel a transaction when it fails to receive the member ID from the mobile terminal 11 within a predetermined time period (e.g., within several hours after receiving the sales information and EC site ID from the EC site 18). In this case, the server 12 may notify the EC site 18 of the failure to complete the payment and cancel the product selection.

According to an aspect of the present embodiment, the customer may make a payment using his/her mobile terminal 11 without transmitting card information to the EC site 18.

Further, a case may be contemplated where the same customer purchases products both online and at a physical store. Oftentimes, a store may run an EC site or be affiliated with an EC site. However, in conventional systems, even when the same customer purchases an item at a store and purchases an item online at an EC site, it has been difficult to recognize that the transaction at the store and the online transaction were made by the same customer because the store and the EC site use different member IDs for the same customer.

In the payment system according to the present embodiment, a common member ID is used at the store and the EC site so that information on transactions of a customer through both sales routes may be unified. From the customer's perspective, store points may be accumulated under a common system regardless of whether a transaction was made at the EC site or at the store, for example.

Although the present invention has been described above with respect to certain preferred embodiments, the present invention is not limited to these embodiments, and various variations and modifications may be made without departing from the scope of the present invention.

The present invention may be implemented in any convenient form, for example, using dedicated hardware, or a combination of dedicated hardware and software. The present invention may be implemented as computer software including a computer program that is executable by one or more networked processing apparatuses. The network comprises any conventional terrestrial or wireless communications network, such as the Internet. The processing apparatuses comprise any suitably programmed processing apparatus such as a general purpose computer, a personal digital assistant, a mobile phone, and a smartphone. Since the present invention can be implemented as computer software, each and every aspect of the present invention thus encompasses computer software implementable on a programmable device. The computer software may be provided to the programmable device using a non-transitory computer-readable medium for storing computer-readable code. The non-transitory computer-readable medium comprises any computer-readable medium except for a non-statutory transitory, propagating signal. For example, the non-transitory computer-readable may be a floppy disk, a hard disk, a CD ROM, a magnetic tape device or a solid state memory device.

The present application is based on and claims the benefit of priority of Japanese Patent Application No, 2012-183353 filed on Aug. 22, 2012, with the Japanese Patent Office, the entire contents of which are hereby incorporated by reference.

What is claimed is:

1. A payment system comprising:
an information processing apparatus, a sales terminal, and a server that are configured to establish communication with each other;
wherein the sales terminal includes
an ID information obtaining unit that obtains ID information of an IC chip, which is installed in or attached to the information processing apparatus;
a sales information generating unit that generates sales information including a payment amount, which is obtained based on product information of a product to be sold; and
an ID/sales information transmitting unit that transmits the ID information and the sales information to the server;
wherein the server includes
a member information database that has the ID information stored in association with a member ID of a member of the payment system;
a member ID receiving unit that receives the member ID from the information processing apparatus;
a member identifying unit that refers to the member information database and identifies the member ID associated with the ID information transmitted from the sales terminal;
a sales information transmitting unit that transmits the sales information, which has been transmitted from the sales terminal along with the ID information, to the information processing apparatus that has transmitted the member ID identified by the member identifying unit; and
a payment processing request unit that receives from the information processing apparatus card information of a card to be used to pay the payment amount indicated in the sales information, and transmits a payment processing request including the card information to a financial institution that has issued the card; and
wherein the information processing apparatus includes
a member ID transmitting unit that transmits the member ID to the server;
a payment approval accepting unit that displays the sales information received from the server and accepts a payment approval;
a card information transmitting unit that transmits the card information that is stored beforehand to the server when the payment accepting unit accepts the payment approval.

2. The payment system as claimed in claim 1, wherein
the member information database of the server has customer identification information of an electronic commerce website registered in association with the member ID, the electronic commerce website being operated by a store that uses the sales terminal;
the ID information obtaining unit receives the customer identification information from the information processing apparatus;
the ID/sales information transmitting unit transmits the customer identification information and the sales information to the server;
the member identifying unit of the server refers to the member information database and identifies the member ID associated with the customer identification information transmitted from the sales terminal; and
the sales information transmitting unit transmits the sales information, which is transmitted from the sales terminal along with the customer identification information, to the information processing unit that has transmitted the member ID identified by the member identifying unit.

3. A server that is configured to establish communication with an information processing apparatus and a sales terminal, via a network, the server comprising:
a member information database that has ID information of an IC chip of the information processing apparatus stored in association with a member ID of a member of a payment system;
a member ID receiving unit that receives the member ID from the information processing apparatus;
a member identifying unit that refers to the member information database and identifies the member ID associated with the ID information that is transmitted from the sales terminal;
a sales information transmitting unit that transmits sales information, which is transmitted from the sales terminal along with the ID information, to the information processing apparatus that has transmitted the member ID identified by the member identifying unit; and
a payment processing request unit that receives from the information processing apparatus card information of a card to be used to pay a payment amount indicated in the sales information, and transmits a payment processing request including the card information to a financial institution that has issued the card;
wherein the information processing apparatus includes
a member ID transmitting unit that transmits the member ID to the server;
a payment approval accepting unit that displays the sales information received from the server and accepts a payment approval; and
a card information transmitting unit that transmits the card information that is stored beforehand to the server when the payment accepting unit accepts the payment approval; and
wherein the sales terminal includes
an ID information obtaining unit that obtains the ID information of the IC chip of the information processing apparatus;
a sales information generating unit that generates the sales information including the payment amount, which is obtained based on product information of a product to be sold; and
an ID/sales information transmitting unit that transmits the ID information and the sales information to the server.

4. An information processing apparatus that is configured to establish communication with a sales terminal and establish communication with a server via a network, the information processing apparatus comprising:
a member ID transmitting unit that transmits a member ID of a member of a payment system to the server;
a payment approval accepting unit that displays sales information that is received from server and accepts a payment approval; and
a card information transmitting unit that transmits card information that is stored beforehand to the server when the payment accepting unit accepts the payment approval;
wherein the sales terminal includes
an ID information obtaining unit that obtains ID information of an IC chip of the information processing apparatus;
a sales information generating unit that generates the sales information including a payment amount, which is obtained based on product information of a product to be sold; and
an ID/sales information transmitting unit that transmits the ID information and the sales information to the server; and
wherein the server includes
a member information database that has the ID information stored in association with the member ID;
a member ID receiving unit that receives the member ID from the information processing apparatus;
a member identifying unit that refers to the member information database and identifies the member ID associated with the ID information transmitted from the sales terminal;
a sales information transmitting unit that transmits the sales information, which has been transmitted from the sales terminal along with the ID information, to the information processing apparatus that has transmitted the member ID identified by the member identifying unit; and
a payment processing request unit that receives from the information processing apparatus the card information relating to a card to be used to pay the payment amount indicated in the sales information, and transmits a payment processing request including the card information to a financial institution that has issued the card.

5. A computer program product comprising a non-transitory computer-readable medium having a computer program recorded thereon that is executable by the information processing apparatus as claimed in claim 4, the computer program when executed causing the information processing apparatus to perform the steps of:
transmitting the member ID to the server;
displaying the sales information that is received from the server and accepting the payment approval; and
transmitting the card information that is stored beforehand to the server upon accepting the payment approval.

6. The computer program product as claimed in claim 5, wherein
the computer program causes the information processing apparatus to perform a further step of storing the card information in a storage device; and
the step of transmitting the card information upon accepting the payment approval includes transmitting the card information that is read from the storage device to the server.

7. The computer program product as claimed in claim 5, wherein
the sales terminal includes a point of sale register; and
the ID information obtaining unit uses a radio frequency identification reader to obtain the ID information of the IC chip, which is installed in the information processing apparatus or attached to the information processing apparatus.

8. A computer program product comprising a non-transitory computer-readable medium having a computer program recorded thereon that is executable by the server as claimed in claim 3, the computer program when executed causing the server to perform the steps of:
receiving the member ID from the information processing apparatus;
referring to the member information database that has the ID information of the IC chip of the information processing apparatus stored in association with the member ID and identifying the member ID associated with the ID information that is transmitted from the sales terminal;
transmitting the sales information, which is transmitted from the sales terminal along with the ID information, to the information processing apparatus that has transmitted the member ID identified by the member identifying unit; and
receiving from the information processing apparatus the card information of the card to be used to pay the payment amount indicated in the sales information, and transmitting the payment processing request including the card information the financial institution that has issued the card.
